(19) United States
(12) Patent Application Publication
(10) Pub. No.: US 2014/0351271 A1
(43) Pub. Date: Nov. 27, 2014

(54) MEASURING PARTICIPATION IN CONTENT PROPAGATION ACROSS A DYNAMIC NETWORK TOPOLOGY

(71) Applicant: GLSS, INC., San Francisco, CA (US)

(72) Inventor: Derek Fairchild-Coppoletti, Oak Bluffs, MA (US)

(73) Assignee: GLSS, INC., San Francisco, CA (US)

(21) Appl. No.: 14/218,392

(22) Filed: Mar. 18, 2014

Related U.S. Application Data
(60) Provisional application No. 61/789,894, filed on Mar. 15, 2013.

(51) Int. Cl. G06F 17/30

(52) U.S. Cl. CPC G06F 17/30038
USPC 707/749

(57) ABSTRACT

Systems and methods may measure and rank a user's role in propagation of content within a population of users. In one aspect, the systems and methods allow a user to register a piece of content and to refer the registered content to a second user. The second user may refer the registered content to other users. The systems and methods track the propagation of the registered content among the users, and rank a user's relevance in propagating the registered content among the other users.

### RELATED APPLICATIONS

This application claims priority to U.S. Provisional Application No. 61/789,894, entitled SYSTEMS AND METHODS FOR MEASURING PARTICIPATION IN CONTENT PROPAGATION, filed Mar. 15, 2013 and naming Derek Fairchild-Coppolletti as inventor, the contents of which are incorporated by reference.

### TECHNICAL FIELD

The systems and methods described herein relate to systems for monitoring the propagation of content across a population.

### BACKGROUND

Today, data networks allow for easy communication and content sharing among members of a population. Some examples of technologies developed to allow for communication and content sharing include email, social networks and search engines. These and other technologies allow for the dissemination of content across enormous populations of users.

In each of the above technologies, a user engages with the system as part of the process of distributing content to the population. To help users propagate content, these systems provide means to propagate content as well as means to easily mark the content with recommendations, such as “likes” or “favorites”. However, despite the fact that each user is given access to the same tools and means to recommend and propagate content, studies have shown that certain users are more effective than others and have examined the characteristics of those persons. See Yoganarasimhan, Impact of Social Network Structure on Content Propagation: A Study using YouTube data; Quant mark Econ (10:111-150) (2012). Further, some studies have measured the general characteristics of content propagation across online networks and have found that content propagation is often more difficult than originally thought. See A Measurement-driven Analysis of Information Propagation in the Flickr Social Network Cha, et al. ACM 978-1-60558-487-4/09/04 (2009). As noted in Cha, et al., there is little published data on the velocity of viral propagation. Cha et al. collected and analyzed millions of pieces of social network content and determined that “contrary to viral marketing “intuition,”” even popular content does not necessarily spread widely or quickly throughout a network. Moreover, information exchanged between friends is likely to account for the majority of popular content, and the propagation can have a significant delay at each hop.

Additionally, online propagation of information can happen through multiple distribution methods. Presently, there is a lack of detailed tracking information or commonly understood context about different content engagement activities and propagation, and related attributes that can contribute, in general, to their success, including without limitation social proof, social capital, timeliness, and specificity. Thus, it is difficult for users, as those discovering, receiving, engaging with, and propagating content, to understand and prioritize what is more or less likely to be signal versus noise in a given context.

Although online social networks hold substantial promise as mechanisms for content propagation, challenges remain as the rate at which certain content currently propagates may be far slower than originally thought and may not propagate to interested populations despite likely being highly valuable and appealing to that population. The effectiveness of the network may turn on the effectiveness of the individual members as opposed to the efficiency of the data transport mechanisms provided by the network, all in the context of massive increases in volume, diversity, and complexity competing for users' time and attention.

However, even to contemplate the scale and relatedness complexity of users and content, in the context of time, efficiency, and benefits, is very challenging. Simply visualizing a relatively simple social network follower/following mapping of a modest population for one social media service is close to overwhelming, even with sophisticated, user-navigable tools (Please see: http://oxfordinternetinstitute.github.io/InteractiveVis/network/). As such, there remains a need for systems and methods that allow scientists and engineers to measure and adjust user propagation of referral and introduction to content across a population.

### SUMMARY OF THE INVENTION

The systems and methods described herein include, among other things, systems and methods for measuring and ranking a user's role in propagation of content within a population of users. A number of different types of systems and methods will be described with reference to certain figures. But it is to be understood that these figures are only for illustrative purposes and that other systems and methods may be employed without departing from the scope of the invention.

In one particular system and method described herein, activities by and interactions between users are used to build a computer model of the content network created by the users in discovering, registering, engaging with, propagating and thereby introducing content across a user population. In one particular implementation, different types of interactions between users are weighted and graphed to record their chosen engagement activities that are relevant to the propagation of content across a population. Additionally, the users' choices to measure their acknowledged or actual viewing or propagation of the content is also graphed, to record the introduction of the content among the users of the population. The graphs can be analyzed to measure, optionally, for each user identified within the graph, that user's role in participating with and propagating the content. Measured users may be ranked according to their contribution.

In one particular example, a population of users is provided access to a computer network system that optionally, allows them to register as users of the system. The users can identify and engage with respect to content and use the system to propagate the content across the population. The system, in this particular embodiment, will generate a network model that includes nodes that record and track characteristics of how the content propagates through the population and will record within the network model related activities of respective users. The recorded information can be analyzed to determine the users' role in propagating the content.

In one embodiment, the method allows a first user of the system to register a piece of content by assigning the content a unique identifier. The method generates the network model by creating a graph of content propagation and user activities, and to that end the method creates a root node of a graph or network. The root node represents registration of the content by the first user and the graph or network represents a set of traceable associations between the registered content and the population of users. The traceable associations have information that describes the process, among differentially weighted options, the user employed to engage with respect to the content, and thereby another user.

The graph records the association between the registered content and the first user as a path in the network. The method then allows the first user to share a traceable link associated with the content with at least one other user. The method records whether the other user processed that shared content referral, typically by activating a redirect link that allows the system to deliver the content, or a means to access it, to the user. Processing the shared content means the user is deemed to be introduced to the content and the method records this introduction as a specific type of path in the network between the other user and the first user depending on the type of engagement activity that resulted in the traceable link.

The method allows the other user to continue propagation of the content, typically by sharing a different traceable link with one or more other users. In some embodiments, sharing includes sharing a link or a pointer to certain content and, optionally, may be multiple mappings to the same content. The sharing of a link may create a unique association through a central associative node as basis within a measurement incentivized context for recording engagement and sharing that is discoverable, and not associated with a particular intended recipient. Once associated with particular target recipient(s) or discoverer(s) of the referral, the method records the sharing as one or more paths in the network model between the users.

Through such a process, the method creates a graph of the engagement, propagation and introduction to the content through the population. Using the graph, the method can rank the users relative to each other as a function of the order in which a user introduced the content to other users. These rankings may indicate the respective role a user played in the participation with and propagation of content across the population, directly and indirectly. In one embodiment, ranking includes scoring a user's role by analyzing the user's activities recorded in the nodes, links, relationship paths, and other structures of the graphs. Typically, but not always, the scores of different users are ranked or grouped into positions with one or more users at a position.

The methods described herein can be a computer process of any type including a computer program, an app, an application as a service, or any suitable computer program.

### BRIEF DESCRIPTION OF THE DRAWINGS

The systems and methods described herein are set forth in the appended claims.

However, for purpose of explanation, several embodiments are set forth in the following figures.

FIG. 1A is a schematic block diagram of an exemplary system environment in which some embodiments operate;

FIG. 1B is an example of different weighting measurements resulting due to different types of engagement activities among similar content networks.

FIG. 2A depicts one interface for accessing a system as described herein.

FIG. 2B depicts one interface for accessing a system as described herein;

FIG. 2C is a depiction of one network model of a content propagation process;

FIG. 3 shows a diagram of an exemplary content network;

FIG. 4 depicts a flow chart diagram of one process for creating a network model;

FIG. 5 depicts example node and relationship data structures of the type that can be maintained by a computer system;

FIG. 6 depicts activities and relationships between users and between content and other graph model entities;

FIGS. 7A and 7B depict examples of a graph model for recording suggestions with respect to content and people.

FIGS. 8-10C show diagrams of exemplary content network and processes for altering or measuring such networks;

FIG. 11A depicts a graph and a process for determining measurement points along the paths.

FIGS. 12A and 12B show additional system diagrams.

### DETAILED DESCRIPTION

In the following description, numerous details are set forth for purpose of explanation. However, one of ordinary skill in the art will realize that the embodiments described herein may be practiced without the use of these specific details. In other instances, well-known structures and devices are shown in block diagram form to not obscure the description with unnecessary detail.

The systems and methods described herein include, among other things, computer systems that monitor and track propagation of electronic on-line content across a population. The system records the users and their engagement with the propagating content and records the methodology of engaging with the content. The system builds a network model of the process by which users propagate and otherwise engage with content. The network model may be employed to determine the scope and success of a respective user's participation in the propagation and other use of content through the population.

In one implementation, the systems include one or more servers that support a plurality of client systems. A user may access a client system and interact with the computer system for the purpose of registering content and engaging with the content, including sharing referrals to content that may be of interest to that user and other users on the network. A user can employ the computer system to generate and provide to a user for the user to distribute, or the system may, distribute on the user's behalf, one or more such referrals to facilitate discovery and awareness about subject content (including meta information and recipient-specific information about such content), introduction to and distribution of content among a population.

In another aspect, described herein are methods that allow a user to join a content network. Joining includes activation by a given user of another's traceable link, or optionally, a permitted propagating user causing a given targeted user to join a content network, for example as recipient of targeted personal sharing by the propagator. The amount, method, order and other attributes of users joining a content network may be utilized as units for recording propagation, by which discovering or recipient users of the system are also provided an opportunity to contribute to the measurement of user engagement and propagation. A given user may be joined to a content network proactively or passively via the engagement actions of multiple other users.

Optionally, as part of such measurement opportunity, upon activation of an associated system link or button, if a given user is subject to system exposure with respect to given content, the user may be provided with current context regarding the content and the user's choices for measurement with respect to the content, including, for example, different measurement weights for different propagator engagement activities, and different users for whose engagement activities to choose for measurement allocation. Content context might include summary meta-descriptive information, such as the name of the descriptive title and/or host of such content, the results of prior measurements with respect to such content network, and other users who are known to have been active with such content, and the like. Such exposure information provides a user with informed choices with respect to system measurement.

Users may be able to bypass exposure, for example if there are not multiple choices available among measurement weights or propagating users, or simply for user preference or convenience. Bypassing exposure might be set as a user default associated with a user's account generally, or under certain circumstances.

Introduction is an event by which a referral recipient user is redirected to a content host to view or access, or otherwise acknowledges or demonstrates prior access to, such content, and causes measurement of associated types and weights of engagement activities, including, as applicable, their own viewing/access and the propagation by other user(s). Introduction may result from activation of another user's traceable link by a recipient user, or activation of a specific type of secondary link (often referred to herein as a redirect link), button, or other trigger provided by the system as part of rendering exposure. Either of the foregoing may result in the user being traceably introduced to the content.

Alternatively, a user may be deemed to have joined the content network and to have been traceably introduced to the content by identifying and registering it with the system.

Once a member of the content network and introduced for measurement purposes, a user may engage with content in a number of manners, including as described herein with reference to the Figures provided. These engagement activities may provide a basis of propagation for the content network, as other users activate traceable links associated with such propagating users' engagement activities, thereby joining content networks, optionally being exposed to content context, and as applicable electing to be introduced to such content for system measurement purposes and further propagating through additional engagement activities themselves.

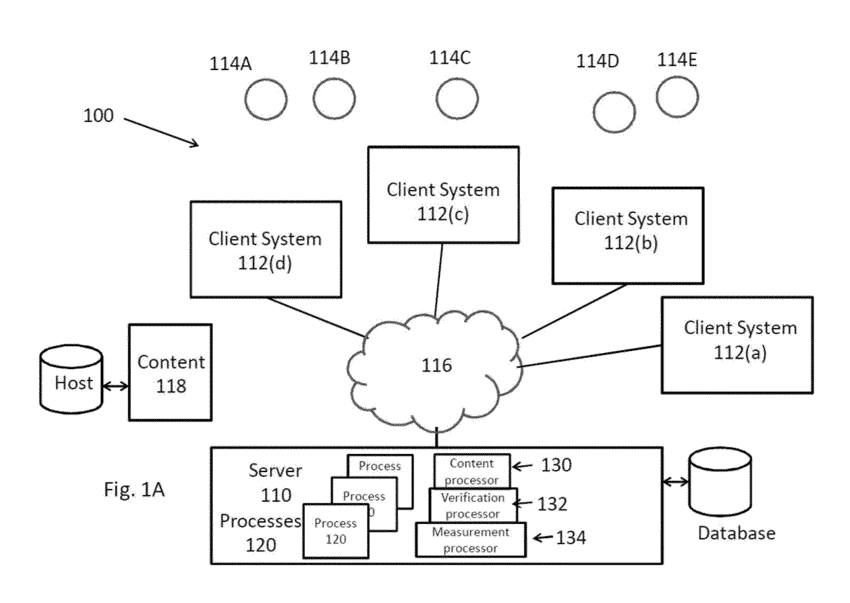

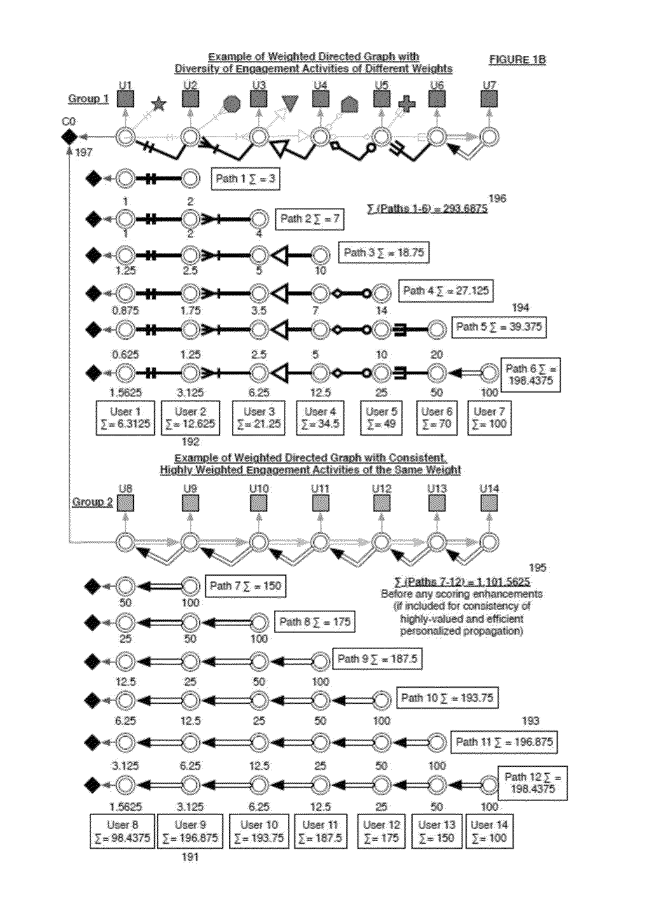

FIG. 1A depicts one such system 100, which includes a server 110, a computer network system 116, a plurality of clients 112(a) through 112(d), and a population of persons and/or organizations depicted as 114(a) through 114(e). The server 110 executes one or more processes 120, which may be computer programs executing on the server 110, and which allow the server 110 to communicate with the client systems 112, review content 118, and carry out other operations. Additionally and optionally, the server 110 may include one or more processors that carry out certain functions for tracking and measuring propagation of content across the population 114. For example, the server 110 may include a content processor 130, a verification processor 132 and a measurement processor 134.

As depicted in FIG. 1, members of the population 114 can access client system 112 to interact through the computer network 116 with the server 110. The server 110, as will be described below, can be any conventional computer server system, and the computer network 116 is typically the Internet. Client systems 112(a) through 112(d) can be any suitable client system such as a smartphone, a laptop or desktop PC, a tablet computer, or any other suitable device capable of accessing a server such as the server 110 through a network such as the network 116. The population 114(a) through 114(d) represents a body of persons or entities such as organizations, corporations, or any other kind of entity, that are types of entities that typically share content amongst themselves. The content can be any kind of content such as an article, a video, comments from a blog or any other kind of information of the type a referral to which can be shared or otherwise referred between different entities. In FIG. 1A a piece of content 118 is depicted, and the content 118 is typically digital content of the type that can be distributed across a computer network such as the computer network 116. A referral from one member of the population 114 has one or a series of traceable links traceable or other methods or applications by which a user is made aware of the content (including pursuant to the provision of meta or related information of potential interest to recipient) and/or introduced via re-direction to a content host or by serving of content file(s) to a recipient, or through some other technique. As further described below, in one embodiment, a recipient 114 in the population receives an exposure page with related meta data and other information as well as a re-direct link for introduction to the content, which the user may activate for introduction. The exposure page and the related meta data typically provides to the recipient some information about why the recipient may be interested in the content that can be reached by activating the re-direct link. For example, the meta data may be a note to the recipient that indicates the content 118, accessible through the re-direct link, is a spreadsheet having information that the referrer deems likely of interest to the recipient. In another embodiment, a user may set a default with respect to a user node as a profile property, and system will on referral activation bypass any meta or other awareness information and proceed directly via tracked re-direction to content host for deemed introduction.

As described above, a referral such as the referral of digital content 118 shown in FIG. 1A is often distributed among or made available for discovery by members of a population 114 through distribution over a network like the network 116. The system 100 described herein allows members of the population 114 to use a computer process 120 executing on server 110 to distribute referrals or content, or to obtain such for separate distribution by the user via another means, to other members of the population 114 and to record and measure their participation with and role in the propagation of referral and introduction to that content 118 among the other members of the population 114.

To this end, a member of the population 114 such as member 114(a), can access a client system such as the client system 112(d) and access a computer process 120 through the computer network 116. The member of the population 114 can register as a user of the system 100 and then use the system to register and/or engage in manners facilitating propagation of the content 118 to members of the population 114 via one or more referrals thereto.

In one embodiment, the system 100 allows users 114 to register as users and engage other members of the population 114 for the purpose of propagating content 118 through the population 114. The system 100 may track the registration of users and the engagement activities of the users and build a network model representative of the users and engagement activities associated with the propagation of the content 118 across the population 114. The network model created by the system permits recording of different types of engagement activities by users, which may be differentially weighted for measurement of users' various choices and roles in registration, propagation, and other interaction with respect to content. The following tables 1B-1, 1B-2, and 1B3 include examples of basic graph elements used to build a mathematical model for measurement, and certain different common user engagement activities, and how such activities might be weighted, recorded and visualized in such a graph model.

TABLE 1B-1
Summary Graph Model

KEY: (node_vertex)-[:EDGE_RELATIONSHIP]->(node_vertex)
e.g. (entity)-[:ACTION/MODIFICATION]->(entity),
e.g. (noun)-[:VERB]->(noun)
Note:
“->” Directionality

| | |
|---|---|
| 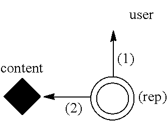 | (1) (user_representation)- [:REPRESENTS]->(user) (2) content<-[:REGISTERS]- (user_representation) “(user_representation)” shortened to “(rep)” in Tables 1B-2 and 1B-3. |

TABLE 1B-2
Summary Graph Model

| | | Examples-Create Trackable Associations |
|---|---|---|
| Generally Discoverable- | | to People & Content. Discoverable via |
| No Initially Associated Intended Recipient | | Activation of Associated Traceable Link |
| 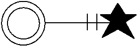 | (rep)-[:TAG_CREATE]->(tag) | Tag: “Vespa” |
| 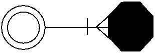 | (rep)-[:TAXONOMY_CREATE]->(taxonomy) | Taxonomy: Catgegory “Motor Vehicles” |
| 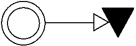 | (rep)-[:GENERAL_POST_CREATE]->(gen_post_link) | Traceable link distributable anywhere, accessible by anyone |
| 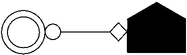 | (rep)-[:COMMENT_CREATE]->(comment) | Any comment or message. |
| 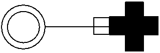 | (rep)-[:PREDICTION_CREATE]->(prediction) | Prediction that content will surpass 1 million views within next 24 hours. |

TABLE 1B-3
Summary Graph Model

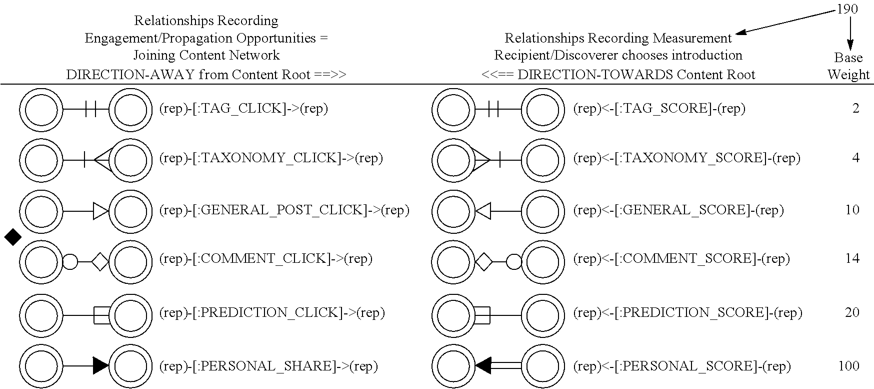

FIG. 1B depicts, in conjunction with the materials from Tables 1B, an example of results of such differential weightings through a network model of measurement. The various engagement activities and resulting propagation and introductions among two separate groups of users, Group 1 and Group 2, are measurably recorded, resulting in different measurements per user (User 9 vs. User 2, Compare 191 & 192), by propagation path (Path 5 vs. Path 11, Compare 194 and 193), and for the sum of all such paths (Compare totals at 195 vs. 196), despite the content (197), number of users, order, sequence, and number of paths being essentially the same for each group. Detailed descriptions follow as to how these content networks may be started, built, measured, analyzed, and managed.

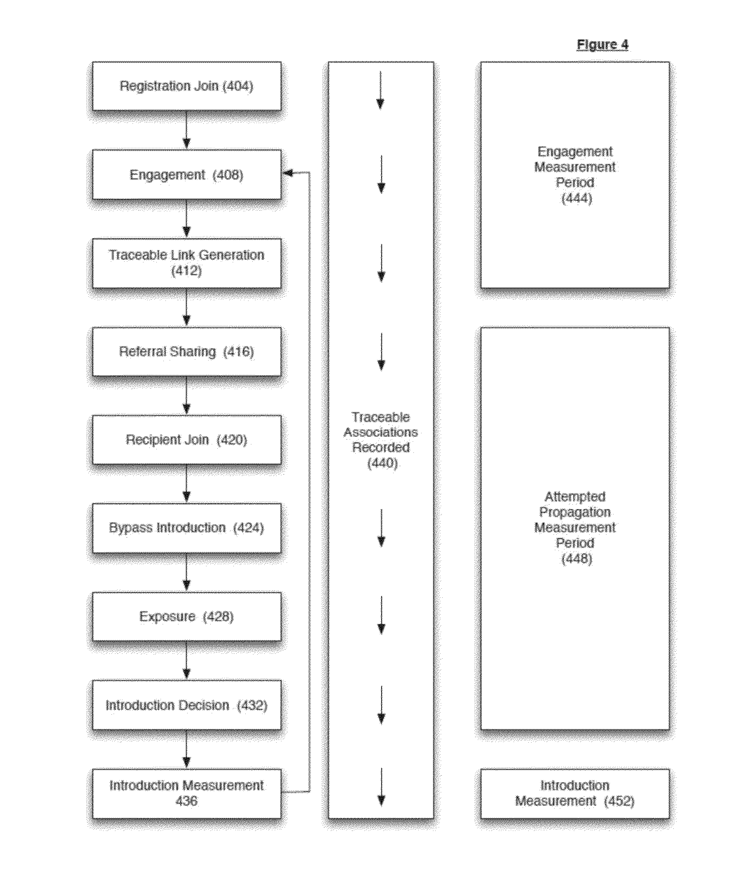

Each Content Network, such as the Content Network CN0 depicted in FIG. 1B, or CN1 in FIG. 3, can be represented as a sub-graph of a system graph, wherein the system graph represents the aggregation of different sub-graphs. A Content Network Sub-Graph has a node, such as the node C0 (197) depicted in FIG. 1B or C1 (302) depicted in FIG. 3, which is the special vertex Cₓ that represents and records the subject content as the root of such weighted directed sub-graph.

Note that from a graph theory perspective, a graph may have many different sub-graphs, and sub-graphs may be thought of as graphs with multiple sub-graphs mappings of their component parts, often in different ways. Thus, a system graph may contain many sub-graphs, and sub-graphs within such sub-graphs, not all of which is a content network sub-graph rooted at v_{Cx}. Measurement is possible with respect to such content networks, but also with respect to their component parts and other graph entities, individually and with respect to sub-graphs formed thereof. An example of some potential relevant measurement approaches of the system follows.

Let Graph G be of vertices v and edges e, with a certain weight functions applicable to certain directed sub-graphs of G or certain of their respective paths P (or users U, or their representations with respect to participation with certain content).

Let w(i,j) be the resulting weight of a weight function of a directed edge if there exists an edge e=(vᵢ, vⱼ), or denoted more simply as e(i, j), and let w(i,i) be, as a result of such function, a weight of the vertex vᵢ (as is sometimes similarly used in notation of weighted adjacency matrices which may describe such weighted graph relationships). Multiple weights and weight functions may apply, at any given time and as changed from time to time, and be measured with respect to the same vertex or edge, and may be separately or specially denoted as such.

Of graph G, let H be a Sub-Graph for which there is a special sub-graph root vertex vc representing certain content, Cx, registered with the system.

Let H further be comprised of (i) recorded propagation in a direction outward from v_{Cx}, and (ii) recorded measurement from events of content introduction in the direction toward vcₓ, each among representations of a population of users measurable in part as a series of one or more Paths, each of which may have allocated corresponding specific weights pursuant to a weighting function.

Of Sub-Graph H, let P^{w}=e₁e₂ . . . eₓ be a path, then its weight is w(P)=Σ^{x}ᵢ₌₁w(eᵢ)

An example w(eᵢ) path weight function consistent with some weighting examples provided herein would vary as a function of path distance from the event that is the cause and occasion of the measurement at the start vertex, or tail, e₁.

For example, w(eᵢ)=BW*0.5^{d}, where BW is the vertex base weight amount applicable to this type of engagement activity measured upon user introduction, and d is the distance (number of edges) along the path from v₁ of e₁=e(v₁,v₂) applicable to the user triggering measurement, the start vertex or tail of the path (in this case at the leaf of propagation resulting in v₁'s introduction), to the end head vertex of the finally measured edge (in this case, v_{Cx}).

By way of example, as the weighted paths drive measurements of user activity represented by vᵢ, w(e₁) for User 1 at the initial tail vertex of e(v₁,v₂) with d at v₁ of e₁=0 yields BW*1=BW for User 1 at applicable w(v₁,v₁). w(e₁) for User 2 at the terminal head of e(v₁,v₂) and initial tail of e(v₂,v₃) with d at e₂=1 yields BW*0.5=0.5BW for User 2. w(e₂) by contrast is a useful measure for User 3 at the terminal head of e(v₂,v₃) with d at e₂=2 yields WM*0.25=0.25 WM for User 3.

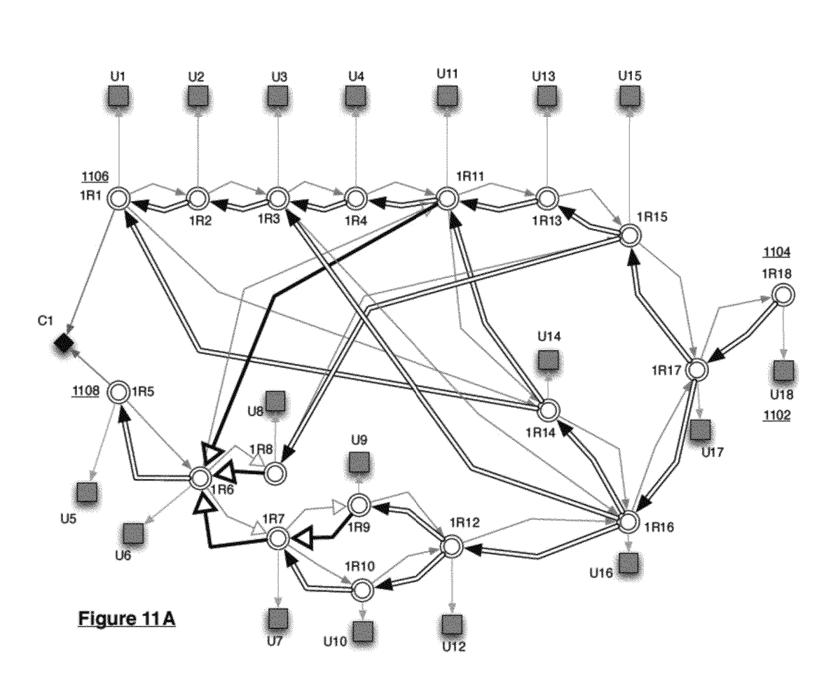

Optionally, multiple paths can be measured with respect to one measurement event, splitting or allocating the weighting function accordingly. These path splits or allocations can be inherited by subsequent path splits or allocations, with consequent multiplicative increases in the numbers of applicable paths. (See FIG. 11A and Tables 11B)

Such weights may be aggregated, adjusted, computed via a variety of algorithms (including without limitation as a function of ratios of given paths per number of user associations associated, or of users per number of attempted engagement activities of a certain type), correlated, or otherwise analyzed by a user or group of users for one, a group, or all sets of measured content(s) and/or applicable associated engagement activities. Descriptions of certain representative embodiments are included below in the context of certain Figures.

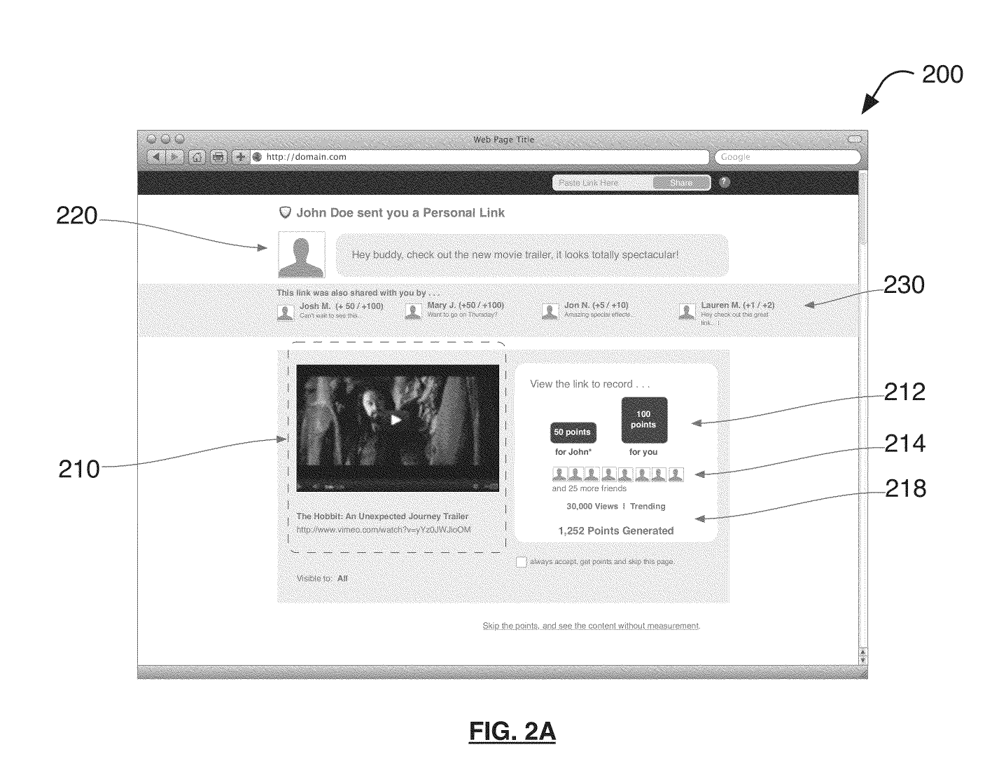

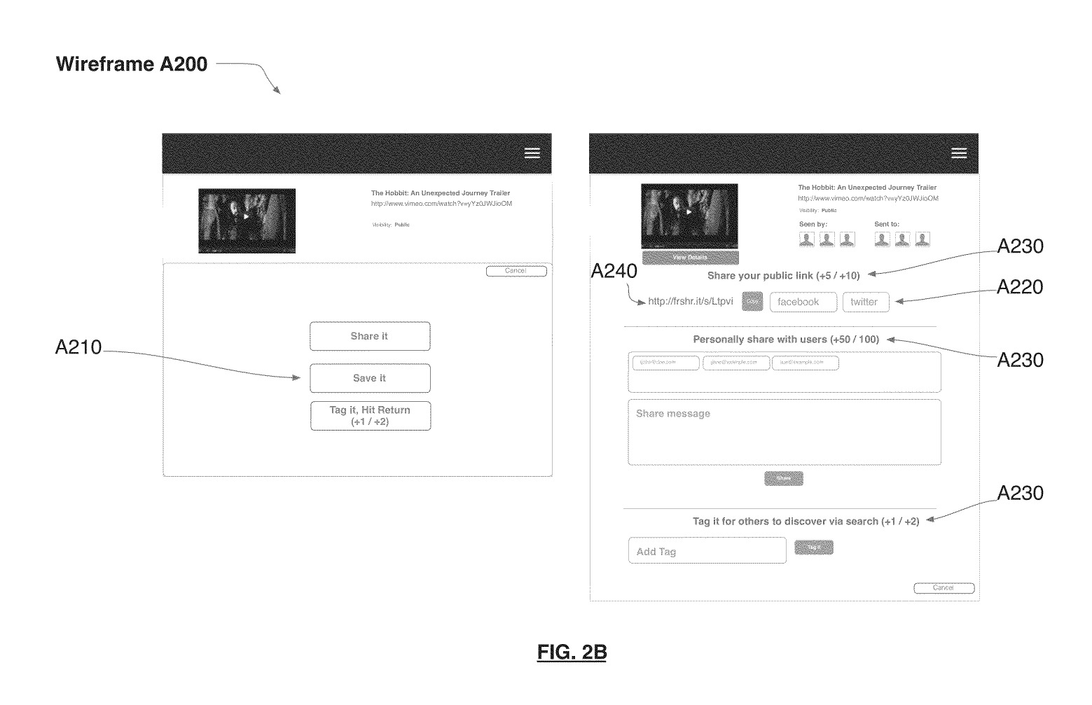

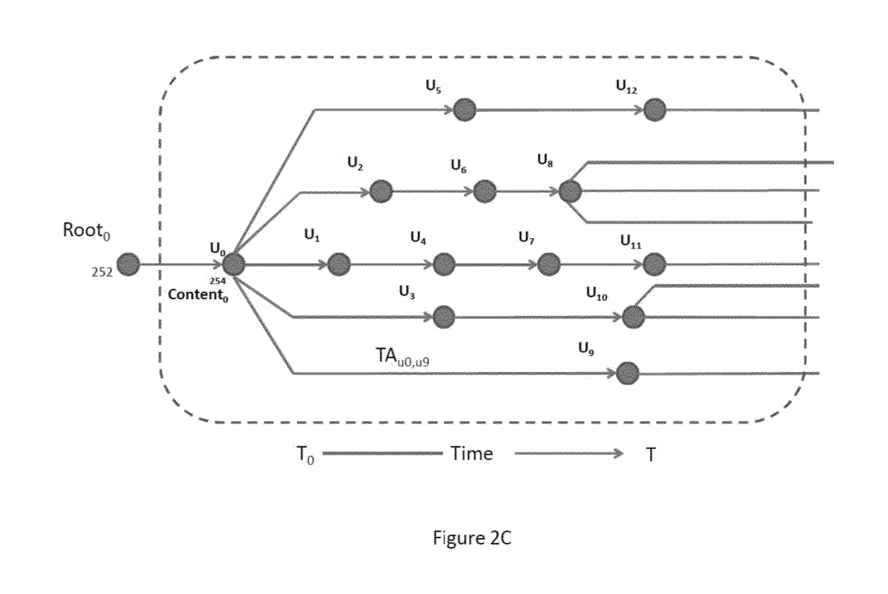

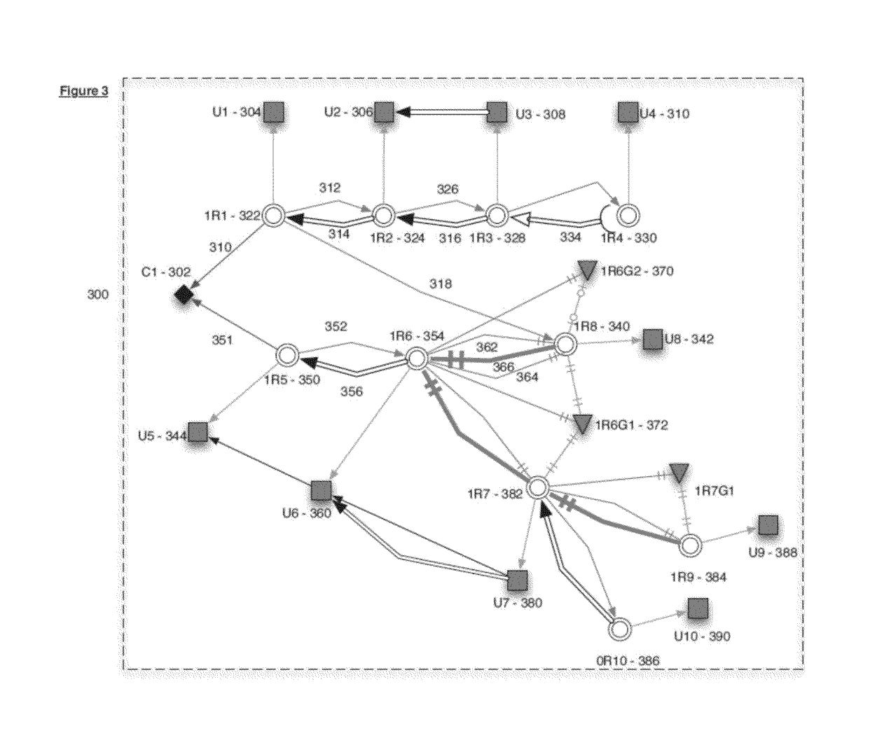

FIGS. 2 and 2A depict one example of a computer process running on a server such as the computer process 120 running on server 110 in FIG. 1A, that allows a member of the population 114 to employ a client 112 to access a computer process 120 and use the computer process 120 to share referral and consequently propagate content and otherwise measure participation among the population 114. In particular, FIG. 2A depicts a wireframe A200 of the result of a computer process that allows a member of the population 114, after having registered and authenticated as a user, to identify and register (A210), as applicable, and thereby create or join a content network, and/or share content referrals with other users via different distribution methods (A220) via different types of referrals valued from a scoring perspective differentially −A230. The user can create and make available a referral embodied in a traceable link (A240), the activation of which by a recipient will provide a site depicted in FIG. 2 providing the recipient with exposure, as further described below, to meta information and, if a registered authenticated user, applicable recipient-specific information, about the subject content, as well as a redirect link or clickable/activatable area 210 that upon activation can redirect a user receiving the link to the intended content at a host, for example Vimeo.com, to result in an introduction of the recipient user to the content. In some embodiments, referrals include notifying otherwise making the users aware of the existence of the content, including facilitating discovery and thereby propagation, and potentially leading to measurable introduction.

In this embodiment FIG. 2 illustrates a graphic 212 that presents to the user receiving the redirect link to the content 210 a representation of points that can be allocated to the user for activating the redirect link on an authenticated, permitted traceable measurable basis and thereupon being redirected to view or access the video at Vimeo.com. In addition to the activatable link 210, the computer process presents a set of thumbnails 214 that may be activatable thumbnails which may allow the recipient user to allocate to other users of the system 100 with recognition that the representation of the other user's association and nature of engagement (including whether a given user is indirectly responsible for recipient's exposure by such referral, and thus eligible for measurement credit upon recipient's activation and further engagement) with this link influenced the decision of the recipient user.

Any suitable links can be used as traceable links. In some embodiments, the traceable links may be links, pointers or apps that form or record or allow for recording of whether a user activated and/or accessed certain information associated with that link, but those of skill in the art will recognize many alternatives that can be employed and the types of techniques used will depend upon the platform and the application being addressed. A referral, as an embodiment described herein, may be a traceable link that upon activation will render the type of information and user experience described above with respect to FIG. 2. A referral typically includes a redirect link or the like for introduction measurement, elsewhere described as exposure. However, if such exposure is bypassed, the referral traceable link will often redirect directly to a content host and record such introduction measurement.

The system 100 allows a user to employ one or more processes 120 through a user interface such as the wireframe A200 depicted in FIG. 2A to identify content that the user deems will be of interest to other members of the population 114. The user can then register that content with the system 100 and begin the process of propagating that content among the population 114. The system 100 will record the propagation process that occurs for that referral and introduction to content. The system uses the recorded process to generate a graph representative of the propagation of that referral and introduction to content through the population 114 as well as to record the activities that individual users of the system 100 undertook which affected the content's referral and introduction propagation, and other participation. The system 100 can, optionally, subsequently use the graph for the purpose of measuring and ranking a user's participation or role within the propagation of that referral and introduction to content through the population 114.

FIG. 2C depicts an example of one such graph. The graph in FIG. 2C is built for a single piece of content, recorded as U₀ 254 as related to a system or content-category management Root₀ 252. As millions of pieces of content may be being propagated at any point in time, the system must use a process, such as a graph process, that can efficiently model the dynamic process that is occurring to refer the content to others in the population 114. Essentially, the system models the development of an ad hoc network. As depicted in FIG. 2C, the recorded data can be reformatted and transformed into a network graph that includes nodes and links. Each node in such content network graph, other than the root content node U₀, and together therewith comprising the primary propagation and introduction measurement elements, including paths, represents a user and each link represents an activity undertaken by a user to register or refer, or otherwise engage with, other users with respect to the content, Content 0. In one embodiment, the measurement processor 134 includes a network model generator for generating network models or graphs like the content networks, and to that end generates models having nodes and associations between the nodes, wherein the nodes represent an action by a user for propagating the registered content and associations represent traceable associations having information that describes a process a user employed to engage another user. These nodes and links will be explained more fully below with reference to FIG. 3.

The depicted system 100 can include conventional data processing platforms such as IBM PC-compatible computers running the Windows or Linux operating systems, SUN workstations running a UNIX operating system, smart phone devices running android or iOS, or any other suitable device. Alternatively, the data processing system 100 can comprise a dedicated processing system that includes an embedded programmable data processing system.

The clients can be computer programs operating on client stations such as those depicted in FIG. 1, that are capable of downloading and responding to computer files, links, applications or the like served by the server 120. In particular, a client process can be a browser program that is capable of forming one or more connections to an HTTP server process for transferring pages from the HTTP server process to the client process. Such a browser process can be the Netscape Navigator browser process, the Microsoft Explorer browser process, the Google Chrome browser process, the Mozilla Firefox browser process, the Apple Safari browser process, or any other conventional or proprietary browser process capable of downloading pages generated by the server processes 120.

It will be apparent to one of ordinary skill in the art, that although FIG. 1 depicts one server, a plurality of servera can be executing simultaneously. Accordingly, the system 100 may be realized as software components operating on conventional data processing systems, such as a Unix or Linux workstation. In that embodiment, the system 100 can be implemented as a C language computer program, or a computer program written in any high level language including C++, Fortran, Java, Python or BASIC.

FIG. 3 depicts one example of a content network model 300 that the system 100 forms to track the participation with and propagation of referrals and introductions to a piece of content represented by root node 302 among the population 114 where portions of that population 114 have registered as users, depicted by, for example, nodes 304, 306 and 308. The system 100 generates the graph 300 to record the traceable associations between the users, such as user 304, and the content 302 in the context of engagement activities that are permitted by the system. In this case, these engagement activities include identifying the content, registering the content, sharing the content generally, for example through an open generally accessible post, or personally, by associating it specifically with an intended recipient user. Additional engagement activities might include without limitation predictions as to content performance generally or for one or a plurality of users (rate of change over time, absolute change, comparative change or aggregate point performance, and the like); commenting on content or others' comments or messages; associated content viewing or activity completion; tagging or organizing content or user activity with respect to content by keyword, taxonomy, category, or attribute of user engagement activity of interest to other users, etc. Any such engagement activities that can be organized and tracked, and may be the subject or mode of user search or discovery or sharing or other engagement with the content and made a representative element of the graph that may be scored or ranked may be included in an embodiment. The traceable associations can also record various states, timestamps, geostamps, device stamps and the like of registration, engagement, association or link generation, discovery/receipt, review and scoring, that is ranking, which can be driven by the different associations; including relationships and either or the combination over time of privacy visibility ad hoc settings with respect to specific registered content and/or user profile defaults set up by those members of the population that have registered as users and set user defaults or inherited user defaults. The traceable associations may also store and record social relationships between the different users as well as those that have introduced users to the system 100. Any suitable traceable association can be used with the systems and methods described herein. In some embodiments, traceable associations include records of actions and optionally characteristics of those actions among users, which may be weighted.

In any case, the system 100 will generate data that can be modeled and managed as a graph such as the depicted graph 300. In the example graph 300, a root node 302 is created when a user, in this case user 1-304, registers the content 302 with the system.

More particularly, at least one user identifies the content and registers it with the system for potential engagement and propagation among other users. This user will be deemed to have joined the content network upon its creation by such first registration, and to have been introduced to such content for measurement purposes. This forms the minimum basis of a content network, which may be modeled as a root node representing the content, and a node representing a system user's interaction with such content, related by a representation of the type of activity the user has had with such content, in this case namely the identification and registration of the content with the system. Thereafter, users may join content networks via (i) activation, or (ii) permitting of association with their account, of traceable links by which the implications of prior engagement activities of other users with such content are recorded.

Optionally, if a user has not already joined such content network via the engagement activities of others, a user may also be permitted to register such content forming an additional sub-graph branch from such content root, thereby joining the content network and being introduced to the content for measurement.

In either case, in operation, registration of the content 302 is recorded by the system generating the path 310 between the representations 322 of the user 304 and of that content 302 and depicted as arrow 310 in FIG. 3. Reference is made to FIG. 3's embodiment utilizing representation nodes for entities (often depicted in the Figures as a circle, indicating a user's representation in the system with respect to a particular content network, versus a user's profile representation as a registered member of the system—often depicted in the Figures as a square). This can technically be implemented in a manner of superior performance relative to overly densely related vertices or multiple references of various properties and/or requiring multiple database joins in a traditional relational database framework; furthermore, it is more domain relevant and human readable when complex configurations of multiple content networks across overlapping user populations are considered. Content is often depicted in the Figures as a diamond.

More particularly, FIG. 3 shows a content network model 300 that records the engagement and propagation of referrals and introductions to content represented by 302 among users of the system and generates and records the traceable associations between the different users of the system and the content. In a first action a user, in this case user 1-304, through its representation 322 identifies the content represented by 302 and registers 310 that content represented by 302 with the system. In one embodiment, registering content with the system can include submitting a URL link to certain content, such as a specific video hosted at Vimeo, to the system. The system can determine whether the URL mapped to the representation of that content has been earlier registered by another user, and separately whether that content has been earlier referred per system methods to any other registered user or specifically addressed intended recipient.

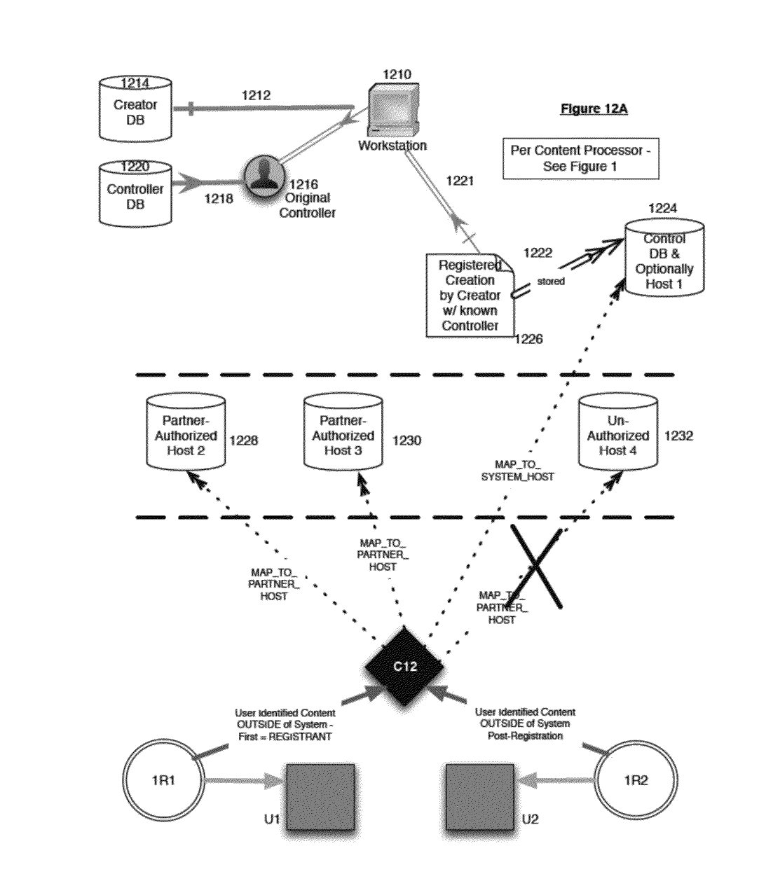

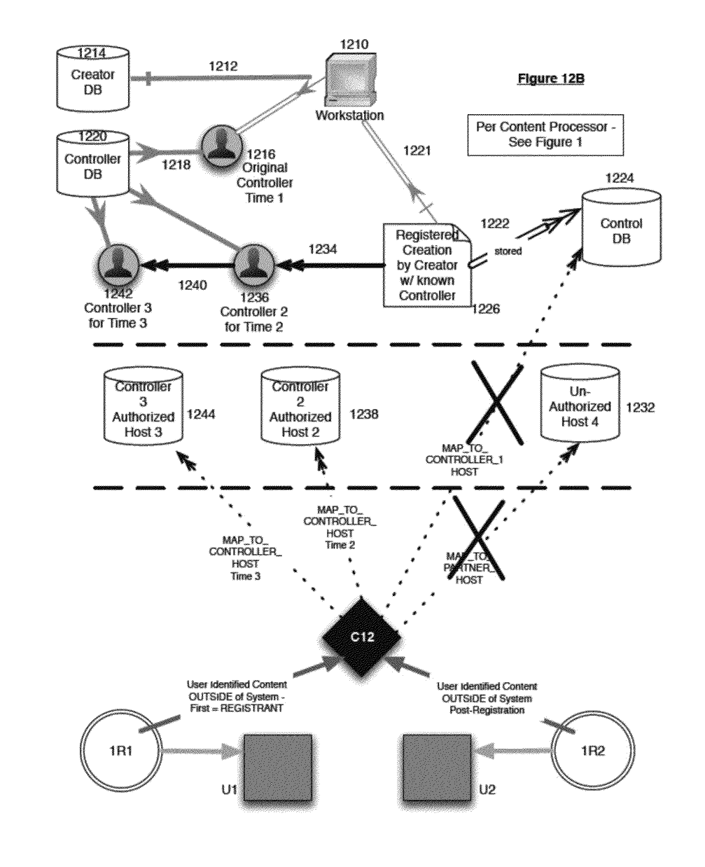

Optionally, if the URL for that content has been earlier registered, the system can notify the user 304 and inform the user 304 that content 302 is already registered and cannot be registered by user 304. Such embodiments might be utilized, for example, when content is controlled and intended to be accessible only via certain referrals for traceable association (See discussion of FIGS. 12A and 12B below), which might automatically or electively be created upon such failed registration attempts in certain instances. Optionally, if the URL for that content has been earlier referred to user 304, the system can notify the user 304 and inform that user 304 is already a referral recipient of content represented by 302, and thus already a member having joined such content network, which thus cannot be registered by user 304.

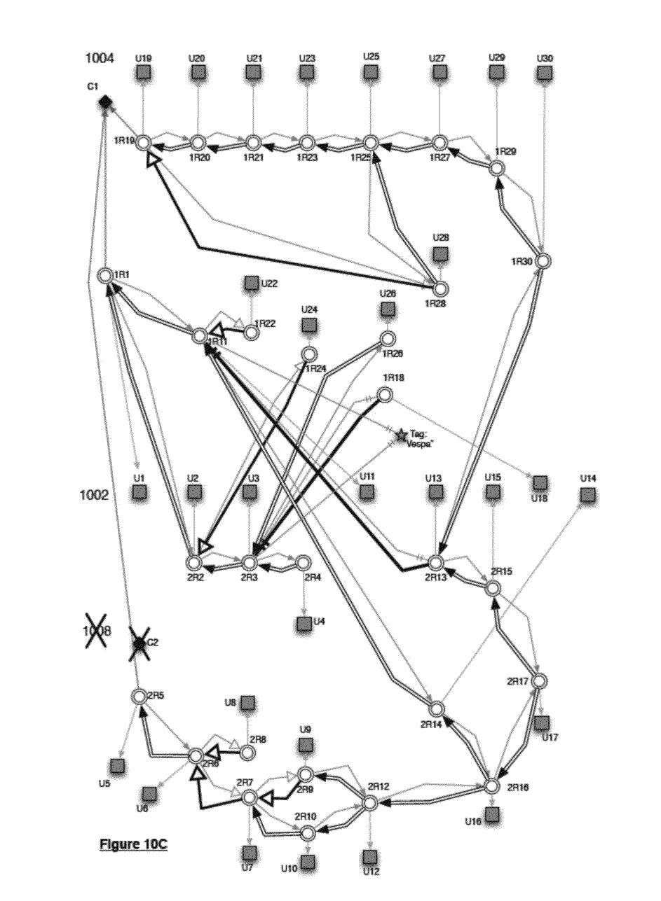

However, if the system determines that content represented by 302 has not been registered by user 304 nor limited against registration for such user as described above, nor has user 304 been recipient of a referral to such content, as applicable, the system allows user 304 to register content 302. For each of the foregoing, such determination is accomplished by comparison against other currently registered content, including mapped substantially similar content (see discussion of FIGS. 10A-10C below), or key and/or relationship mappings to user representation members of associated content networks, or other analysis of system graph entities and related traceable associations. Typically, the system 100 will allow multiple users to register the same piece of content and, as will be described below, can create separate sub-graphs of the propagation and activities started by the respective other users. The sub-graphs can be analyzed as a single larger graph (itself a sub-graph of a system graph) to show the aggregate effect of propagation and other engagement activities. Sharing of referrals by multiple referrers to the same recipient user can cause these sub-graphs to be joined via certain paths, and if multiple referrers are eligible for and allocated referral credit for their role in introduction to content, multiple paths of various lengths, types and compositions and traversing multiple sub-graphs from different content registrants are possible, as discussed with reference to FIG. 11A and table 11B.

In one embodiment, and only by way of example, registering content can mean generating for the submitted URL a hash value that uniquely identifies on the system that URL and may include or map to an activatable link of the type used to create an entry on a webpage or web browser or the like that can be activated to link that web page to the content on a server. In some embodiments, the link generated by the system may include an activatable link that re-directs the user for delivery of content from the host site identified by user 304, in this example, the vimeo.com website. Alternatively, the system may generate an activatable link that delivers content from another content server such as one controlled by the system or a system partner, or provides a unique record of content formerly accessible at a location, for example rendered pursuant to a hash function. This allows the system to record content that has been registered and maintain it at servers that provide for long-term storage, perhaps longer term than that provided by other sites such as vimeo.com, or that provide controlled limited access to content to certain users under certain circumstances, including those under which certain rating and measurements can be tracked, earned, and retained. In any case, the system can generate for the registered content an entry in a database that indicates the URL associated with this content as being registered on the system and can generate activatable links, other pointers, hash records, or the like that can be delivered to the user 304 or otherwise for use.

With registration, the system generates the root node 302 representing the registered content. The system can generate different types of nodes (also, more formally denoted vertices), generally or as a function of their relationships (also, more formally denoted edges) with other nodes, to represent different types of entities using the system in different manners. The content node, one example of which is depicted in FIG. 5, can include a content I.D. and other properties, and one or more content resource locators or other identifiers, hash records, information, applications, or methods that can point to the content of interest and facilitate access or measurement with respect to it. Other data structures for the content mode may be used, and such variations will be known to those of skill.

Turning to FIG. 12A, FIG. 12A depicts, in one particular embodiment of the systems and methods described herein, using a content processor as described on FIG. 1 for registering 1212 as a creator with a unique identifier in a database 1214 a computer or other device 1210 which can create digital content in a manner that can be tracked. Any such creation may be originally associated with control by one or more certain registered controllers, an example of which as depicted in 1216. A content processor may also be used to register 1218 as a controller with a unique identifier in a database 1220 a party (example, 1216) believed to historically, currently, or prospectively exercise partial or total control over the use of content registered upon creation. Similarly, a content processor may register 1222 in a database 1224 the creation 1226 of digital content made and identified for Registration 1221 by generating a unique identifier with respect to the digital content itself, its registered creator 1210, applicable original registered controller(s) 1216, the time of its creation, and, optionally, unique identification of the location, form and/or method of creation and registration. Such optional information may include without limitation unique hash or other technical identification information of that which comprises the content upon its creation registration; GPS coordinates; other hardware, software, or other specialized components used in creation; or other unique creation registration identifier(s) of or other unique identifying information of digital content used in an applicable reduction or combination. Registration of creation can include (i) original de novo content, or (ii) content resulting from reduction from and/or combination with other content, previously creation-registered and controlled or otherwise. Note that FIG. 12A depicts that the controller 1216, through interaction with a system content processor, can determine via which hosts such controlled content is accessible and under what circumstances. For simplicity, FIG. 12A shows that such content is accessible via controller 1216's permission at system Host 1 1224, as well as via hosts of two of controller 1216's partners, Host 2 1228 and Host 3 1230. However, given known control by a controller that is a partner with system, system will not permit mapping via content processor of any re-direct or other access to content via a host not authorized by the controller, thus Un-Authorized Host 4 1232 will not be the destination of any system generated re-direction. Thereby, the system can manage how to measure engagement with and propagation of content, among many potential copies and derivatives.

A control feature of the content processor, depicted in FIG. 12B, may be used to map changes to control of creation-registered content via time stamped relationships, first per relationship 1234, between (a) the content creator and one or more original controllers, here 1216, and (b) one or more subsequent content controllers, here Controller 2 1236 for some second time period Time 2. Thereafter, as applicable, per relationship 1240 from (c) one or more prior content controllers, here Controller 2 1236 to (d) one or more subsequent content controllers, here Controller 3 1242 for some third time period, here Time 3, until a subsequent change (not shown) in controller is recorded; in each case where any prior content controller can be traced via one or more unbroken paths of known control relationships and tenures to the content creator and one or more original controllers. A content processor may be used to manage storing in a host database such associated records of relationships to provenance of control, in FIG. 12B evidenced by 1224. A control feature of a content processor may be used to manage, as permitted by and agreed with the content's applicable controller, the propagation of referrals and introductions to such controlled content. A content processor, upon activation by a user of a referral and/or election of introduction, may manage to which host via which content address(es) such user will be directed via re-direct link or otherwise. Note, for this example, that during Time 2, Controller 2 directs any content access as permitted to be served from Controller 2 Authorized Host 2-1238. Subsequently in Time 3, Controller 3 directs any content access as permitted to be served from Controller 3 Authorized Host 3 1244, during which time the system would not facilitate, serve, or map any re-direct towards Authorized Host 2 1238, even if a copy of the content was still accessible there and users identified such content as part of becoming associated with the applicable content network and then shared a referral thereto. Note also that even if there is no record of control as described above, the system or one or more partners (potentially including sponsors) can similarly influence to which host(s) recipients are re-directed for introduction to content, again which may be managed by the content processor.

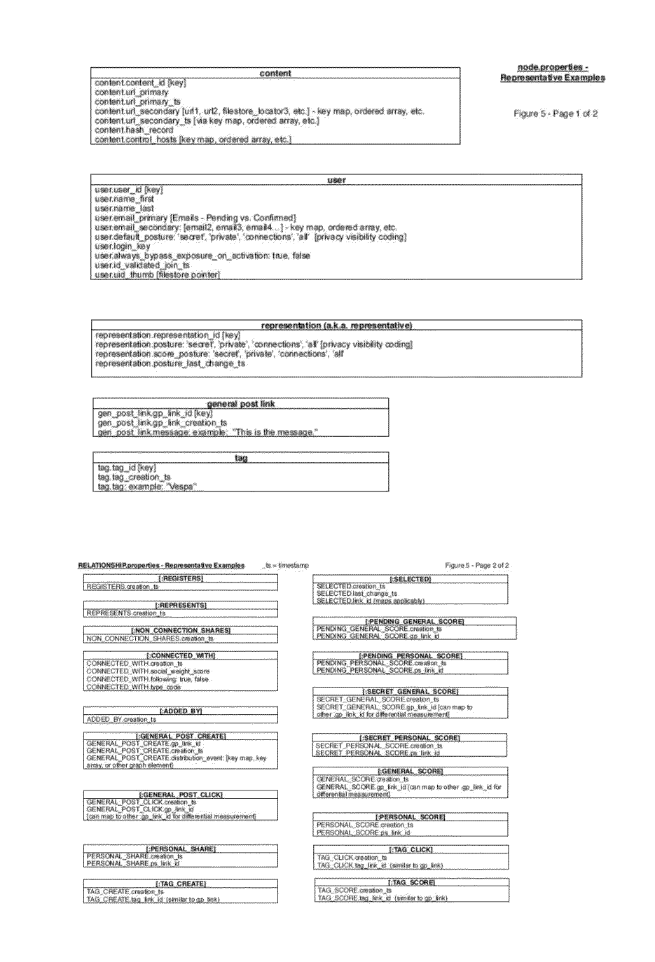

FIG. 4 describes one particular embodiment, the ordered states and several processes of the system, as well as how traceable associations are recorded to build the content network graph model. Further, simplified primary measurement stages are identified relative to the stage of engagement with respect to a given user.

Registration Join (404)—At least one user identifies and registers certain content, thereby joining a content network and being deemed to be introduced thereto.

Engagement (408)—Upon introduction, any user may participate via system-tracked engagement activities with such content, including sharing.

Traceable Link Generation (412)—Engagement activities generate traceable links unique to the type of activity and user whose engagement caused their creation.

Referral Sharing (416)—Traceable links may be used for referral, whereby other recipient users receive, usually via sharing, or discover the referring user's traceable links.

Recipient Join (420)—A recipient user joins a content network, either upon being a specifically targeted recipient or upon activating another's traceable link.

Bypass Introduction (424)—Upon activation of a traceable link, if recipient has a bypass override, recipient is redirected to content at host and measured introduction is recorded.

Exposure (428)—If no bypass override, upon traceable link activation, recipient may be subject to exposure, including information about sharer, measurement prospects, influential meta, social, and performance information, etc.

Introduction Decision (432)—Recipient may elect to activate redirect link or other trigger included with exposure to be measurably introduced to content.

Introduction Measurement (436)—Introduction recorded. One Introduced a new user to the content network can further engage in a measured manner (to 408).

Traceable Associations (440)—All above content network stages cause traceable associations to be recorded in graph model-able manner.

Simplified Measurement Stages—Engagement (444), Attempted Propagation (448), Introduction equates to Propagation Achievement (452).

FIG. 5 depicts one example embodiment of a node structure for a user such as the user 304 and its associated system-wide user-level profile. The user 304 can have a representation 322 that is a node within the sub-graph associated with specific registered content. A user can have one or a plurality of representation nodes as part of different graphs associated with different registered content (each, a content network sub-graph of a system graph), and in one embodiment the system will only permit one representation node per user per content network graph mapping and controlling the registration, engagement activities, propagation of referrals and introductions to specific registered content. The user node can include, as shown in FIG. 5, a user I.D., user name information, user e-mail information, other associated identifying or login credentials, a set of defaults with regard to the user's agreement to accept links shared from certain persons or under certain circumstances (including associated measurement credit allocations), to maintain privacy visibility, and other default conditions that can be set up as appropriate for the application, or keys or hashes linked to mapping to such information stored in relational or other databases or data stores.

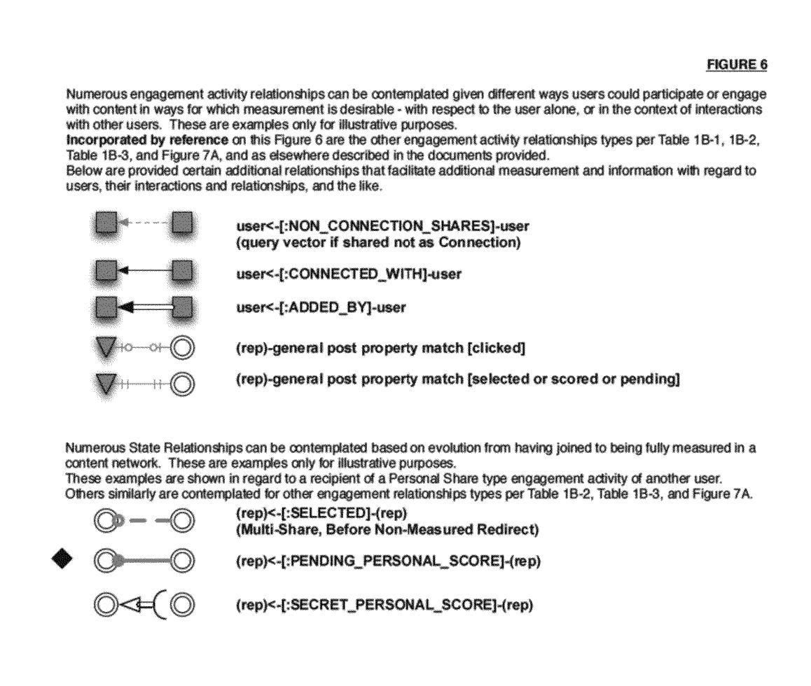

Returning to FIG. 3, from FIG. 3, it can be seen that the system creates the content node 302 and a registering user's representation node 322 and generates a link 310 between the two nodes. The link 310 represents the relationship between the user 304's representation node 322 and the system's representation of the content 302. In this example, the link 310 represents that the content 302 was identified and registered by user 304 represented by 322. FIG. 6 depicts a series of example relationships which, together with the properties thereof and of the entities whose nodes they connect, can be used to associate as well as control and score the system interpretation and measurement of content in the context of the people, users, action and other information that the system has recorded as content has been shared and other actions taken among the users of the system.

Once user 304 through its representation 322 has a registered content uniquely identified and recorded as represented by 302, the user as recorded through representation 322 can engage with, including sharing referrals to, the content it has registered with other members of the population. Those other members can register, if not already registered, with the system and associate their personal information with any user (profile) node that may have been created for them, and have, with respect to a given content network and as linked to their respective user profile node, a user representation created through a node as described above. For example users U2-306, U3-308 and U4-310 have user representations in the system, and each user representation is recorded as a node. In FIG. 3, the user 304's representation 322 has shared a referral to the registered content with the user representation 324 for user 306. This is represented by the path 312 that extends from user representation 322 to user representation 324. The relationship 312 that interconnects 322 and 324 represents that the user 304 represented by 322 created a personal share referral to the content 302 for the recipient 306 represented by 324. The personal share may have occurred by sending an e-mail or via other digital communications or social media, or otherwise personally providing a link to the content represented by 302 to the recipient user 306 represented by 324. As can be further seen by FIG. 3, the user 306 represented by 324 generated a personal referral, this time to intended recipient user 308 represented by 328. This is represented by the relationship 326 that shows that user 306 represented by 324 personally shared the content with the user 308 represented by 328. The user 308 represented by 328 in turn shared the content with user 310 represented by 330. The paths 312, 326 and other paths which show relationships between the different users stemming from the content 302, record engagement activities enabling the propagation of knowledge or awareness and introduction of the content across the users in the system.

Similarly, FIG. 3 shows that the data modeled in graph 300 records how the recipient users having received or discovered a link or other form of referral to the content represented by 302, behaved. For example, the user node 306 represented by 324 has a relationship 314 connecting to user 304's representative node 322. This link 314 records how the user 306 represented by 324 engaged with the content shared by the user 304 represented by 322. In this example, the relationship 314 represents the type of engagement that the user 306 had with the referral to content which in this example indicates that the user 306 activated the redirect link that resulted from activation by 306 of the personally shared referral generated by user 304 for and in some manner provided to user 306. In a subsequent scoring process where the system evaluates the role of user 304 in propagating the content, the system may, optionally in certain embodiments, award a higher value of measurement points, per differential weighting functions based on type of engagement activity, to user 304 for personally sharing a referral to the content represented by 302 with another user in the system, relative to points available to be recorded for other types of engagement activities. Additionally, the system may award measurement credit in the form of points or otherwise to user 304 for having identified the content represented by 302 and registering it on the system. FIG. 100 also shows that the server 120 may include a measurement processor. The depicted measurement processor may be a computer process executing on the server 120. In one embodiment, the measurement processor analyzes the paths within a graph and accesses data via the nodes and relationships, through records such as those depicted in FIG. 5 and FIG. 6, to collect certain weighting parameters and other data about the activities users took on those paths. The measurement processor can analyze this data to determine the measurement credit each user in the paths, and the graph should receive. Further, the measurement processor can change allocation commitments per agreement among two or more parties to any applicable measurement structure or function. Thus, if a recipient and a referrer agreed to a different allocation of points than a given measurement function provides, the measurement processor, in some embodiments, can adjust the measurement allocation between those two accordingly. Additionally, the measurement processor may award the user measurement credit as a function of parameters selected by the user and representative of conditions under which the user will accept such measurement. A measurement processor may be used to advise a user toward an activity wherein the advice suggests user activities that can increase measurements with respect to a user and such user's associated paths, engagement activities, user account and the like, and is generated by the system and representative of an estimated value set at a given time under the relevant conditions.

In further embodiments, the measurement processor may generate advice with respect to engagement activities. The advice may guide a user in selecting which of multiple referrers or prospective recipients or distribution or discovery mechanisms to select, and through other choices typically offered to help the user maximize their available measurement. The advice may be generated through a graph correlation analyses of one or more estimated longest paths of most efficiency or highest weighted value types of activities and consequent branching based on current or prospective participation of other users. Further optionally, the measurement processor may allow the system and/or its users to change or enhance measurement weight functions and other system attributes, for example to increase momentum or reach (including targeting) of content propagation. In one embodiment, the measurement processor tracks the propagation of the registered content among the users, and ranks a respective user's relevance in propagating the registered content among the other users, as a function of the order in which the respective user referred content to other users.

FIG. 3 further shows that the other recipients of the content such as user 310 represented by 330 and user 308 represented by 328 also engaged with the personally shared referral links provided by the respective referring users. The user 310 activated the link and was re-directed to or served access to view the subject content at host, but did not further share referral to the content with others. The user 310 in fact set visibility posture with respect to such content on a restrictive privacy mode (perhaps given user 310's perspective that it was not desirable or objectionable), such that while user 310 may be measured for activating the referral to be introduced, the referrer user 308 represented by 328 will not be. That information can be recorded within the relationships 334 and used to allocate a certain amount of points to user 310 for having activated the referral from user 308 and for being willing to be traceably introduced to the content. Such type of relationship embodied as e(v₁, v₂), with a private v₁ 330 at leaf initial tail node, and the sharer v₂ 328 at the terminal head node might have a weight function such that only the private tail node in such instances would be counted for measurement. A higher number of points may have been allocated by the system if the user 310 had continued to share referrals with other users, thus further propagating awareness about and introduction to the content 302 among the population of users, including recognizing the role of user 308 and those other users who played an indirect role in user 310's introduction.

The type of sharing or other engagement activities resulting in propagation or other recorded participation can vary depending upon the options made available by the system and the choices of the users. For example, in FIG. 3 the user 304 represented by 322 also personally shares information with user U8-342 represented by node 340. The personal share is represented by the relationship 318 that records the engagement of user 304 with user 342. However user 342 has chosen instead to give sharer credit measurement attribution for the referral pursuant to one of user 342's two click activations of general post links generated by user U6-360 represented by 354, the embodiments of such general post referrals represented by 370 and 372, and made to be placed, perhaps on a web page, or on a wall, blog, communication stream or through other means, to make each available to some non-specifically intended recipient(s), including potentially the general population, to view. This reflects introduction via an engagement activity with a differently valued weighting function (in this case, lower base weight—See Table. 1B-3) relative to the personal sharing examples previously discussed. Such differential weighting can be quite instructive, as in this case a user 342 chose a lower value option among those including higher weighting value choices. Such information could be used, for example, to indicate stronger social strength or common niche interest appeal between users, or the like, especially as correlated with other recorded measurements of behavior.

FIG. 3 further depicts that other users such as user U5-344 represented by node 350 can also register content and the system can develop a separate sub-graph network based on user 344's registration. In particular, FIG. 3 shows that user 344 identified and invoked content registration and the system created user representation node 350 related to user node 344 as depicted in FIG. 3. A link 351 is established between user representation 350 and the content 302 to show that the user 344 represented by 350 has registered the content. In this case, the system may allow a second user such as user 344 to identify the same content 302 and, upon registration, build a branch sub-graph of the content network (itself a sub-graph of a system graph). In this case the user 344 shares the content with user 6-360 represented by node 354. As indicated by the relationship 352 the user 344 represented by 350 can make a personal share to the user 360 represented by 354, whom is shown via the relationship toward content root 356 to have elected to be measurably introduced thereto. In turn, the user 360 can create the referral posts represented by 370 and 372, which are made available to non-specifically associated users (the general population, or a smaller group who can see a link via some distribution or posting method protected by some authentication or the like) and thereby exposed to U8-342 perhaps by 342's clicking a link on the wall page of the user 360. This in turn can generate relationships 362 and 364 that record the relationships between user 6-360 as represented by node 354 and user 8-342 represented by node 340, particularly that user 342 activated two separate general post referrals generated by user 360. Further, relationship 366 records the traceable associations created when user 8-342 represented by node 340 activated the re-direct link for introduction via a general post share of the content made by the user 360 represented by node 354. As discussed above, the system can use this relationship 366 to award some number of measurement points to user 360 for having posted the information and for having a user access that posted information, and for user 342 having activated for introduction in a manner with properties attributing credit for user 342 (as recipient) as well as those whose role directly or indirectly resulted in and were selected by user 342 for measurement scoring, namely users 360 and 344, respectively.

As can be seen from references to FIGS. 3-6, the systems and methods described herein build a data model, in this embodiment represented as a graph or collection of sub-graphs, that record relationship-by-relationship with associated properties the engagements that users make with content and that users make with each other when propagating referrals and introductions to that content among the population of users. The system can then use the recorded information about the engagement and propagation and the user interaction with that propagation and those propagation activities, to determine the type of role (and its associated differential weighting, efficiency, consistency and other attributes) each user played in such propagation through the population. In either case, the systems and methods described herein create a system that measures the direct and indirect role a party has in registering, engaging with and thereby propagating referrals and introductions to, and other participation regarding, content through a population.

Returning to FIG. 2, one example of the sharing and propagation of referral and introduction to content is depicted. In particular, FIG. 2 shows that one user, 220, has sent a link via the system to another user. As described with reference with FIG. 3 this can be a personal share represented by a relationships in the graph and recording the activity and engagement of user 220 generating a personal share to another user. The information rendered to the recipient can include the activatable link 210 to the content and additional metadata information such as, in one embodiment, activatable photo thumbnails 214 or other relevant information that can be used to provide further measurement incentive or further context 218 for the recipient user to influence the recipient user to activate the re-direct link for the content they have been exposed to and to be measurably introduced to that content pursuant to such re-direct activation. Additionally, the referral exposure page can include other content(s) and/or activatable links associated with content(s) which have been bound for associated measurement with the primary content, the subject of such exposure, and which may be additionally and relatedly mapped in a system graph model. In some embodiments, the activation of the link 210 can lead to a pre-re-direct or post-re-direct advertisement or other content that the recipient is to experience as applicable and respectively with, before, or, upon their return to a system-enabled resource, after, they get to view the content, or it could include a link to a site (including as may be opened as an iframe, or similar window, etc.) where the recipient user may be asked to purchase a good, take a survey, or perform some other activities that may be required by the system for the referring user to receive a greater allocation according to a certain measurement weight function that is being offered to incentivize propagation referral to and introduction of the content or certain recipient user performance associated therewith. In either case, the system can record the activities performed by the recipient user and those activities can be recorded as part of the relationship between the recipient user and the referrer and stored as, or as properties of, such relationships, such as the 314 depicted in FIG. 3, connecting such corresponding nodes.

FIG. 2 also depicts an example of an exposure page that has been delivered by a referring user to a recipient wherein the content being referred has been shared with the recipient user by multiple referring users. In this case, the referral 200 includes a banner 230 that indicates the different referring users, in addition to 220, that have shared this link 210 to the content with the recipient user, their associated messages, as well as the relative measurement weights applicable to such referring users' engagement activities—if the recipient user were choose them for full measurement allocation. The recipient user, in some embodiments can choose or potentially allocate credit among the multiple referrers for being introduced by these different referrers to the content coupled to link 210.

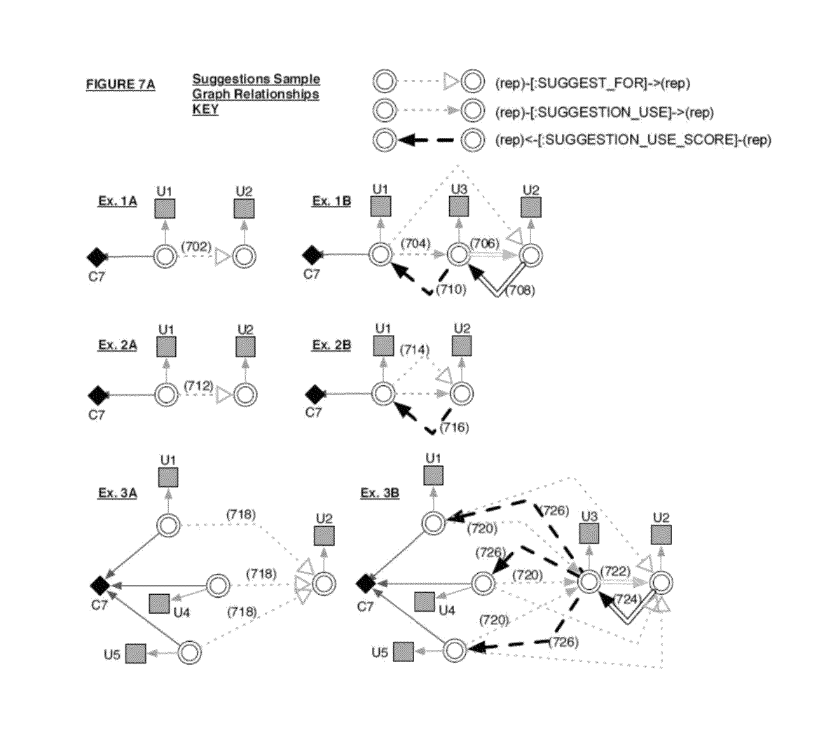

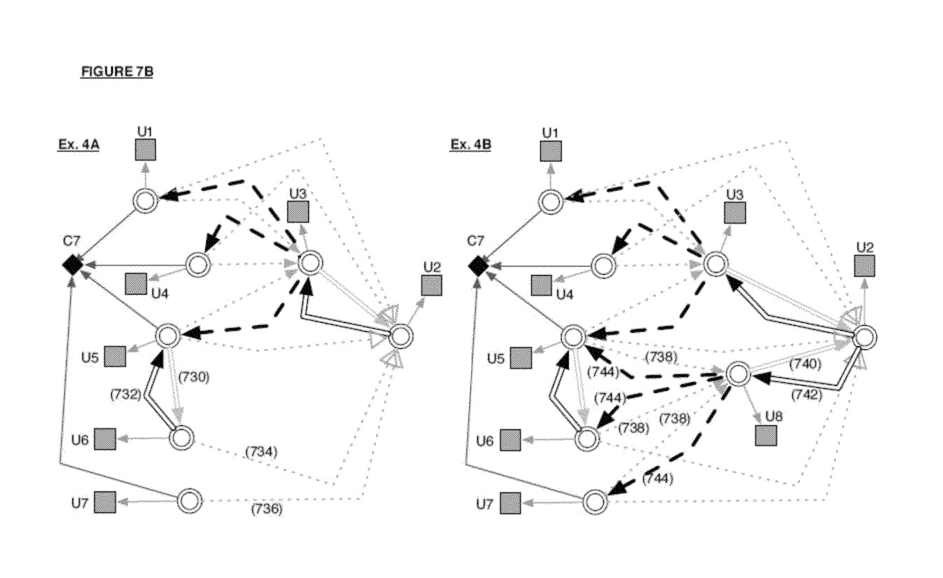

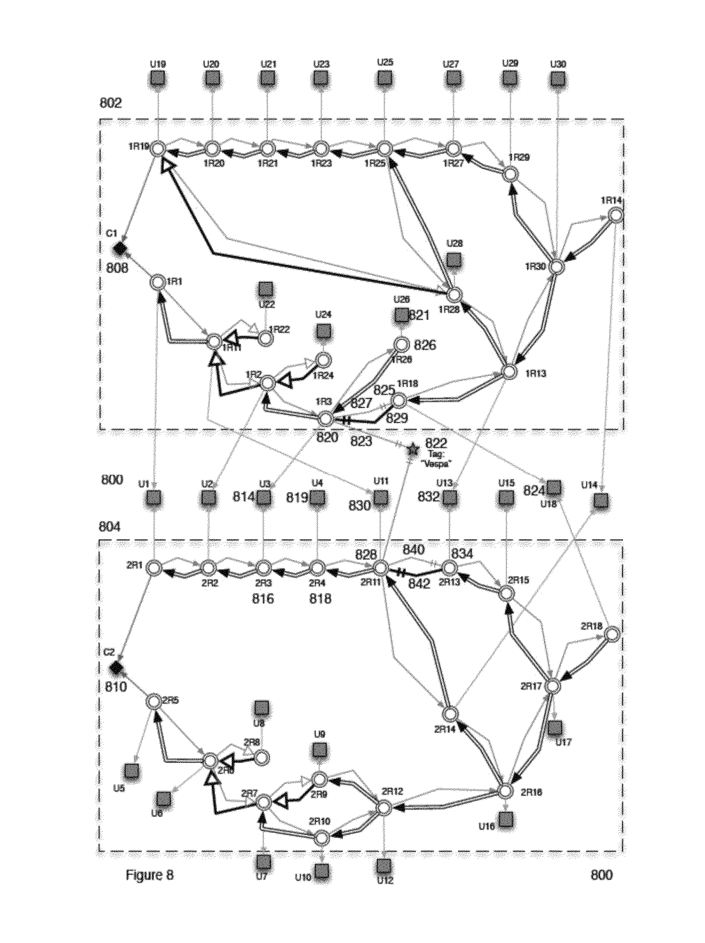

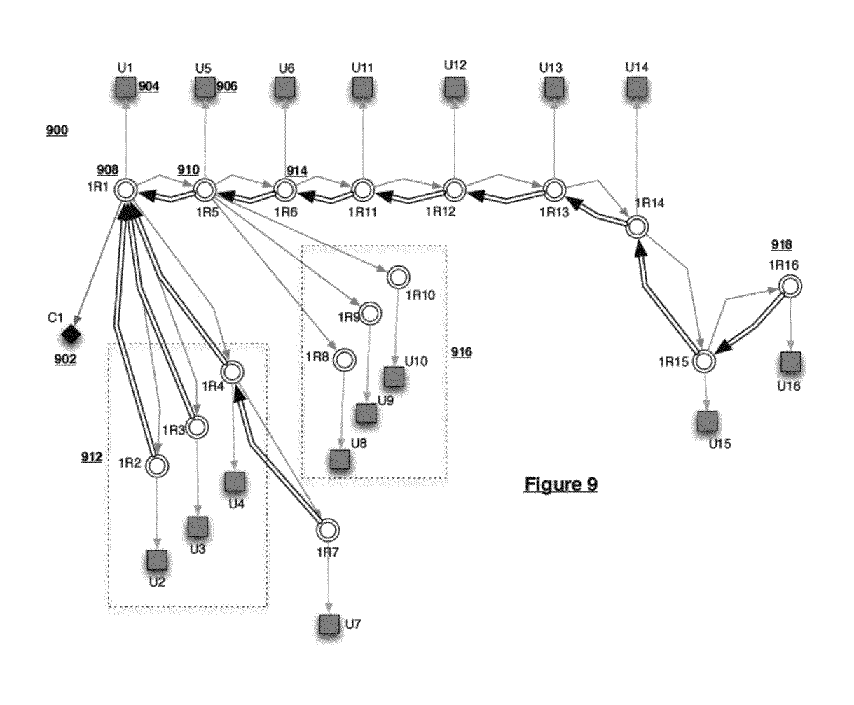

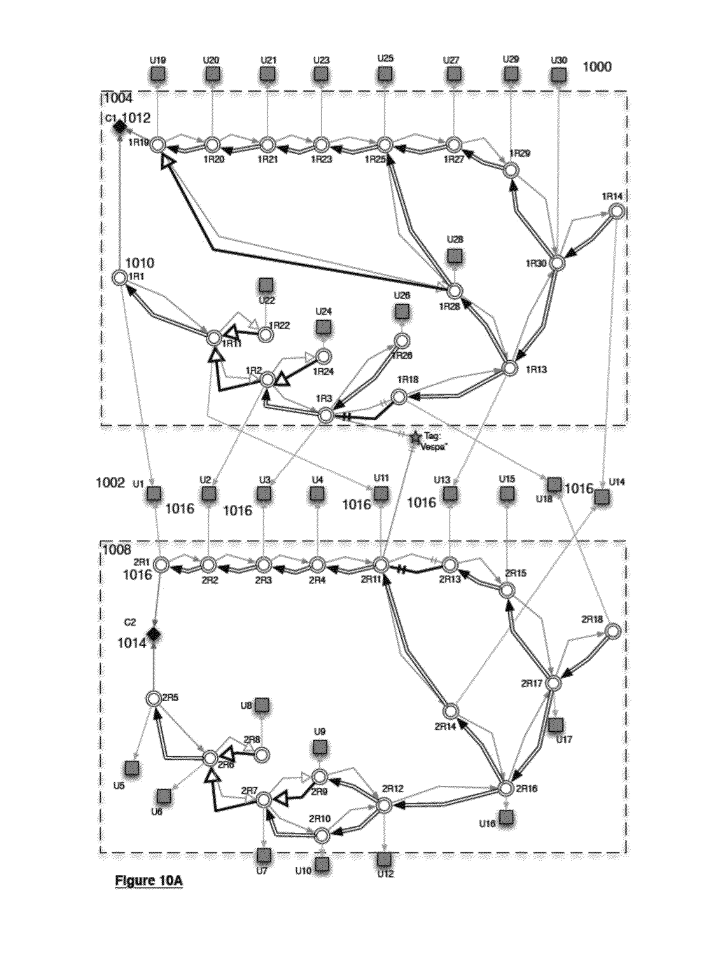

Similar to a user engagement activity such as tagging content with a keyword (discussed below in context with FIG. 8) that can be the source of traceable associations by which a referral can occur, an embodiment of the system contemplates tracking and measuring each user's direct and indirect role, alone or as correlated with others, in associating content suggested to be of potential interest to a target user, but not as thereby referred directly by the user(s) making such suggestion. Such target user may be a prospective referrer or recipient of a referral. User makes traceable association between (I) content itself, or one or more tags or taxonomizations or other user engagements by which content can be associated, and (II) another targeted user as a suggestion. Suggestions may be used to provide, weight, or otherwise help inform decisions by (a) a third party user, (b) a user him- or herself if later used (either the subject or maker of the suggestion), or (c) system with respect to the targeted user. Such decisions may include choices for binding content matched with user-selected content. If a user's suggestion is directly used to inform a decision resulting in a referral of another party, the system may model the user's effect on the content propagation as described below. If a user's suggestion is used to inform or weight, via inference, correlation, combination, aggregation or similar association, the provision of one or more separate suggestions informing a decision resulting in a referral of another party, measurement credit is based on such user's indirect suggestion role. This embodiment contemplates the data modeled via a graph structure as similarly elsewhere described, including the ability to score or rank such suggestions based on the nature, structure, and allocations associated with the various comprising paths. While this may be modeled and implemented in a number of ways consistent with the teachings of the system and methods described herein depending on the situation, one of the simplest to visualize is shown in FIGS. 7A and B.

FIGS. 7A and B, wherein the suggestion by a suggesting user creates a type of relationship that structurally appears similar to a direct personal share to a recipient, but one that might not be immediately made visible to such recipient (e.g. the recipient might or might not know such suggestion has been made). If such suggestion is subsequently used by another user with respect to such target, such party may be graph-structurally inserted via a set of relationships between the user who recorded the suggestion and the target, for example as a personal sharer, and with such personal sharer's use of such suggestion being recognized by a relationship from the sharer to the user who recorded the suggestions causing measurements of such successful suggestion. FIG. 7A shows three examples. Per below, all user action is typically recorded per their representation nodes in content networks, identifiable per the prior teachings above and the Figures.

FIG. 7A—Example 1. U1 suggests content C7 for U2 (702). U3 finds suggestion, and attributably uses (704) it to personally share (706) content C7 with U2. Optional, such suggested content could be combined/bound with other content as well. U2 elects introduction & measurement, creating measured path for U2->U3 (708), and U3->U1 (710).

FIG. 7A—Example 2. Alternatively, U1 suggests content C7 for U2 (712). U2 is able to discover suggestion, attributable or not to U1, and is measurably introduced (714). U2 elects introduction & measurement, creating measured path for U2->U1 for suggestion (716).

FIG. 7A—Example 3. Alternatively, over time, U1, U4, and U5 all suggest content C7 for U2 (718). U3 finds the suggestions, and, as highly suggested, attributably uses (720) them to personally share (722) content C7 with U2. U2 elects introduction & measurement, creating measured path for U2->U3 (724), and U3->U1, U3->U4, and U3->U5 (726).

FIG. 7B—Example 4. Example 4 picks up from Example 3B on FIG. 7A. U5 then personally shares (730) the content C7 with U6, who has been measurably introduced (732). U6 suggests content C7 for U2 (734). U7 also registers content C7 and suggests it (736) for U2. U8 might via a strong social relationship weighting rank (not shown) with U5, U6, U7, in different optional implementations, discover only, have prioritized in display, or only choose such users for use of their suggestions among the population of users who have recorded suggestions (i.e. U1 and U4's suggestions are not included in use by U8). In any event, U8 identifies and elects such suggestions, and attributably uses (738) them to personally share (740) content C7 with U2. U2 elects introduction & measurement, creating measured path for U2->U8 (742), and U8->U5, U8->U6, and U8->U7 (744). Note that multiple separate sets of measured paths for measured introduction to certain kinds of content may be permitted in certain circumstances, as tracking and measuring repeat exposures and introductions and consequent follow-on engagement activities may provide valuable information in the propagation of certain content among a population.

By way of further example, if 4 different users independently made suggestions traceably associating a certain user content with a certain brand or product category, that correlated suggestion information could be provided in context to a user making a decision about a referral to such user about whom such suggestions had been made. If such suggestions were used for a referral, those parties providing the suggestions might be awarded certain measurement credit for the indirect role their suggestions played, including as a function of the ultimate success of such recipient as part of the associated direct and/or bound content networks.

FIG. 8 depicts a large graph 800 that has two sub-graphs 802 and 804 which are represented as sub-graphs by showing each of the sub-graphs 802 and 804 surrounded by a box having a dashed line. This indicates that the two sub-graphs 802 and 804 can be understood as part of the one larger graph 800 (which could be thought of as a simplified representation of a system graph). In either case, FIG. 8 shows that there are two sub-graphs 802 and 804 each of which represents a different content network and in this case the two content networks 802 and 804 have overlapping users, that is, some of the users of the graph 802 are the same users of the graph 804.

Sub-graph 802 is a content network formed around the content 808 to track referrals of content 808 as it passes through the population of users. The content 808 may be, for example, a YouTube video on Vespa repairs. This content 808 may be of interest to certain users, and users such as the user 1 will propagate referrals to this video on Vespa repairs to other users that may be interested in this content. That population of users receiving referrals to the content 808 may also receive referrals to other content such as the content 810 about which sub-graph 804 is formed. The sub-graph 804 shows a content network formed around the content 810, which may, for example, be a Vespa blog post having schematics of rare Vespa parts. The sub-graph 804 has some of the same users as sub-graph 802, and in this case users 1, 2, 3, 11, 13, 14 and 18 are members of both networks for the content 808 and content 810. However, these users join in different orders and in different ways to the different networks.

The graph 800 also shows how one user may join both content networks 802 and 804. In particular, sub-graph 804 includes user 3 identified by node 814. The user 3 can have a representation node 816 within the sub-graph 804, and a representation node 820 within sub-graph 808, and that user 3 can participate within the content network 802 in different ways. For example, user 3 is shown as having a representation node 816 that refers content to the representation node 818 for user 4 (819) and receives an indication that the user 4 has been introduced to the content that was sent by user 3, and thus measurement credit will be given to user 3 and 4 because of user 4 819 electing measurement of the referral that user 3 sent (which would have referred user 4 to some website that would have presented the content 810, which again is a blog of schematics for rare Vespa parts).

FIG. 8 similarly shows user 3 814 via representation node 820 personally sharing to and being measured to have introduced user 26 821 via representation node 826, for which comparable measurement credit may be given to users 3 and 26 as was given to 3 and 4, respectively, as described above, if the same weight function applies. In addition, FIG. 8 shows, though, that user 3 at node 814 can also tag the content 808, that is the video on Vespa repairs, with a term, such as “Vespa”. This is represented by the gray star 822 which is shown as having the user 3's representation node 820 in content network 802 make the tag 822 association 823 (evidenced by a line originating from representation node 820 with two perpendicular hash lines near the head terminating at the tag “star” node 822). That tag was found by user 18 824, probably via search, and this created the vector by which user 18 received a referral via discovery and joined 827 the network 802 at representation 825, and, by election of user 18, measurably introduced 829 to content C1 (808), and for which both user 18 and 3, shown by user node 814, would be given measurement credit, but perhaps at a different level as a function of a different base weight function relative to user 3's successfully measured personal shares with users 4 and 26. (See Table 1B-3 Base Weight examples 190)

In one embodiment, the system 100 includes a search engine for allowing users to search for content. The search engine can search a table of keywords, with keywords associated with one or more piece(s) of content. The keywords, in one embodiment, may be associated with content, at least in part, by users tagging, or otherwise associating certain content with certain keywords. Thus, in one embodiment, the system allows a user to associate the keyword “Vespa” with a video on YouTube showing a repair process for a Vespa engine. Such search engines that allow for tagging of content are known in the art, such as the search facility from Nextopia Software Corporation of Toronto Canada. The systems described herein can provide a user interface for the search facility that records the user engagement that entered into the search facility the association between the keyword with the content, to further record a traceable association between the user and the content, by which a referral traceable link can be created for discovery by another user as associated with such keyword. In alternate embodiments, other system taxonomical or organizational processes may be used instead of a search engine.

In the content network 804, user 11, shown by user node 830, tagged the content 810 with the term “Vespa” (evidenced by a line originating from user 11 representation node 828 with two perpendicular hash lines near the head terminating at the tag “star” node 822). That tag was found and clicked by user 13 represented by user node 832 and as shown by the two perpendicular hash lines near the terminating head representation node 834 for user 13 on the line 840 from user representation node 828, whereby user 13 joined the content network. The reverse direction hashed line representation 842 to user representation node 828 from representation node 834 represents that user 11 and user 13 were measured accordingly given user 13's introduction pursuant to the tagging of content C2 with the term Vespa. The combination of events models user 13's discovery of the content, and therefore, having been referred to the content via such tag association by user 11 (840), the record that user 13 elected to measure the referral and be introduced to the content via that tag (842), resulting in applicable measurement credit to both users 11 and 13, respectively.

The FIG. 8 also illustrates that the systems and methods described herein can include large graphs that include sub-graphs. In some cases, the sub-graphs can be understood as content networks, such as the depicted content networks 802 and 804. However, other sub-graphs of relationships are also generated and can be presented, such as sub-graphs showing a user's relationships to different content networks. For example, the square nodes connected to user 3 814 as a network showing that the user 814 mutually participates in both content networks 802 and 804. In particular, for example, user 814 is represented via a connection to a representation 816 in sub-graph 804 and a representation 820 in sub-graph 802. These two representations record, as a sub-graph of a system graph, this user's participation in these two content networks (themselves, sub-graphs of a system graph).

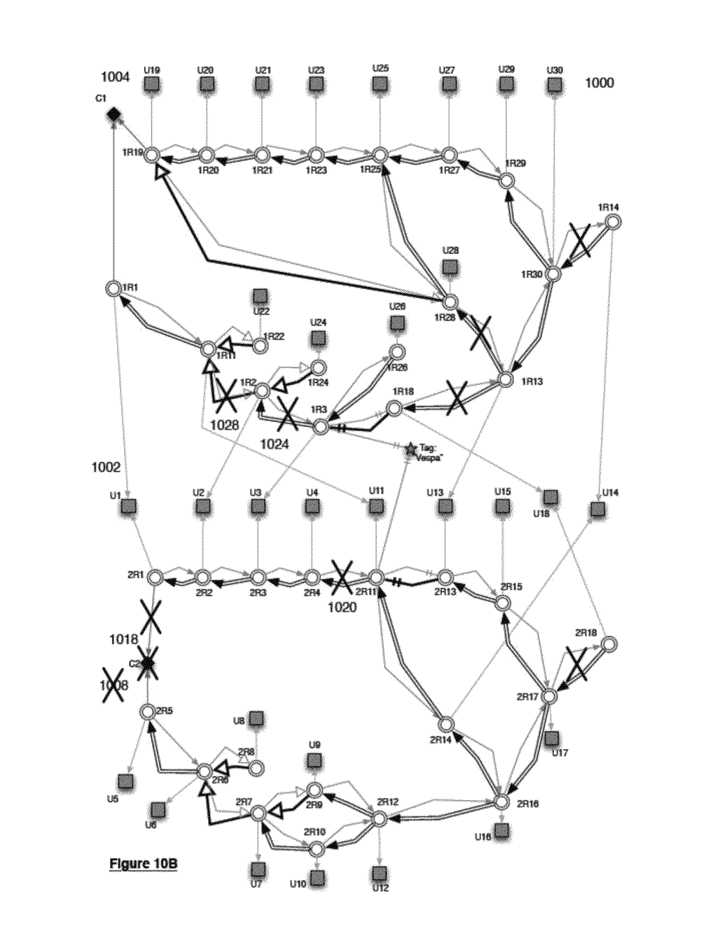

FIG. 9 depicts a content network 900 that shows, among other things, two active users, U1 904 and U5 906 that are engaging other members of the population with respect to certain content. As discussed above, the content network records the participation and engagement activities of each user on the network 900 and allows for each user to be measured and ranked, in one embodiment, according, among other mechanisms, to their weighted contribution in propagating referrals to the content, in this case content 902, to other members of the population. This ranking can be used to determine a user's ranking for propagating referrals to the content, or for propagating measured introductions to the content itself. The content 902 can be any suitable digital content and typically will include news stories, entertainment, an advertisement, an offer to purchase a good or a combination of these.

In one example provided only for purposes of illustration, a personal share score is determined for each user in the content network 900. In this example, U1 904 is determined to have a more efficient sharing measure, scoring four introductions for four referrals. In particular, U1 904 is represented on this content network 900 by the representation node 908. Representation node 908 has four referrals for personally sharing the content with four other members of the population. One share is with U5's representation node 910. Three others are with U2-U4 encompassed by dotted line box 912. All four users' representation nodes have indicated (by the return arrow to U1's representation node 908) that they have activated the referral and have been measurably introduced to the content. Thus, one measure of U1's rank can be calculated as 4/4. Alternatively, without limitation, this could be used as a ratio multiplier as part of a weighting function with respect to general weighted measurement points.

In comparison, U5 has been less efficient or effective. U5's representation node 910 shows four referrals of the content 902, but only the representation node for U6 914 indicates that a referral was activated and a election for measured introduction made. The users U8, U9, and U10 encompassed by dotted line box 916 show that they did not accept measurement of U5's referral, leading to a score of one out of four.

U1 also has generally high consistency along the path from U1's to U16's representation nodes (908 and 918, respectively), which may be an additional measure of effectiveness and lead to a larger portion, for example, of any applicable bonus function or other supplementary allotment beyond base weighted measurement provided for referring users to content 902. Optionally, U5's performance along the path from U5's to U1 6's representation nodes, 910 and 918, respectively, may result in certain measurements of U5 and U1 being adversely affected due to U5's one out of four efficiency which may be used, in part, to create a ratio multiplier that can be applied to any points allocated for participating in facilitating the long referral path to U16.

FIGS. 10A and 10B illustrate one process for merging two content networks. As discussed above with reference to FIG. 8, a user will receive referrals to multiple pieces of content. Sometimes, two content networks will be established, or start to establish, around the same content. Sometimes this happens innocently/independently, and other times persons might intentionally copy content that is successfully propagating, so that they can also propagate in-demand content multiple times or possibly at all if under some control restrictions, and thereby raise their measurement score. Detection of duplicate propagating content can be made by crowd sourcing overlaps/fraud detection and allowing users to flag content that is wrongly duplicated, such as pirated copies.

In any case, when this happens, optionally and preferably, the system puts the two networks together through a merger process that can eliminate wrongly joined users, take duplicative points or other measurements away from the non-deserving users and potentially give points or other measurements to the users who helped identify the overlapping content network, typically by flagging duplicate or substantially duplicate, content.

Pursuant to set theory, let Content Network 1 (CN1) and Content Network 2 (CN2), as sets, be sub-graphs rooted by content C1 and content C2, respectively. It is determined that C2∩C1 by C1=C2 or C1≅C2, with ≅ meaning substantial similarity sufficient for determination of equivalency. The systems and methods described herein contemplate operations to effect: CN1∪CN2, net of certain CN1∩CN2 redundancies associated with v_{C}2 and user representations, wherein ∪ (merger) represents the operation of the union of two sets of sub-graph edges and vertices, and wherein ∩ represents, among such sets, unnecessary or undesirable vertices and edges associated with v_{C}2 and user representations which are graph structurally redundant and/or may cause measurement inaccuracies or distortions, where v_{C}2, between contents C1∩C2, and such other elements are identified for removal.

To avoid duplications or other measurement distortion, upon identification of need for merger, the system may process the graph CN1 and CN2 to eliminate redundancies and into a new merged graph CN1. One process is shown pictorially in FIGS. 10A-10C.

The server of system 100 referenced in FIG. 1 contemplates certain processors, which optionally includes a merger processor to carry out a merger process, which may be a process 120. FIGS. 10A and 10B depict a process 1000 of such a merger processor of system 100 on FIG. 1 that merges two content networks. The process 1000 is depicted by illustrating how the networks change between FIG. 10A and FIG. 10B. In the FIGS. 10A and 10B time progresses from left to right and each representation node has a recorded time of creation or time of joining the content network and has the time of each engagement activity also recorded. This time data can be stored in node and relationship structures, such as the node and relationship structures depicted in FIGS. 5 and 6. Alternative means for storing the time data can be used without departing from the scope of the invention.

FIG. 10A depicts a large graph 1002 that includes a first content network 1004 developed around content C1 and a second content network 1008 developed around content C2. In this example, C1 and C2 have been determined to be too substantially similar to allow for the formation of two separate graphs, each of which may measure the same users separately, resulting in unjust measurement and inaccuracy.

In this process a user U1 identifies content C1 1012 at one point in time (1010) and the same user U1 identifies content C2 1014 at a second point in time as depicted by the location of its representation node 1016 being slightly to the right of content C1. As can also be seen, there are users that are members of both content networks 1004 and 1008. For example, users U1, U2, U3, U1 1, U13, U14, and U18 are members of both networks 1016.

In one embodiment, the process 1000 merges the two networks 1004 and 1008 to recreate circumstances to enable a recipient user to choose across multiple referrers to “reconstruct” the merge network, as if the user knew at the time it was one network and had the right group of eligible referrers from which to choose.

FIG. 10B depicts the activities that occurred on the two networks that are, in one embodiment, to be deleted or modified to merge the networks. The process 1000 removes the registration 1018 of the content C2 by the user representation node 2R1 in the sub-graph 1008. The process also deletes the later-in-time instantiation of the content node C2. These are deleted because they violate an applicable rule that allows a user to identify and register one piece of content only once.

The process then, in this embodiment, analyzes the two content networks and deletes those activities and associated graph model entities and relationships as they were later in time actions of a user that has already interacted with the content on another network. For example, the sub-graph 1004 shows that user U11 was, at an earlier time, referred the content C1 by user U1 and that the U11 representation node 1R11 shows that U11 activated the referral and was measurably introduced to the content. The process 1000 therefore eliminates, as depicted by the cross out 1020, the later-in-time referral by user U4 to user U11 on content network 1008. This elimination at 1020 prevents user U11 from receiving points for viewing the same content (or performing other activities) twice, first on one network built for the content C1 1004 and next on a network built for a copy of the content C2 1008. Similarly, the process 1000 eliminates, as shown by cross-out 1024, the later-in-time introduction event that takes place on content network 1004 between user U2 and user U3. As can be seen from the large graph 1002, this referral and introduction at cross-out 1024 takes place later in time (to the right of) an earlier referral and measured introduction event that U3 took part in on content network 1008. Similar facts cause the process 1000 to eliminate, shown as cross out 1028, the exchange on content network 1004 between user representation node 1R11 and user representation node 1R2.

Other interactions are also removed as depicted by the other cross-outs, until those interactions that violated the system rules are eliminated. The graphs are then merged and a new graph, depicted in FIG. 10C is formed.

The merger process can use a content processor to create, modify, or delete applicable traceable associations, and to store in the host database recipient elections determining then-eligible referrers. FIG. 100 also shows that the server may include a verification processor. The depicted verification process may be a computer process 120 executing on the server 11. In one embodiment, the verification process, among other things, determines whether a recipient user has set default or content-specific parameters, and determine whether a proposed referral of the traceable link matches the default or other parameters required for generation for and, as applicable, transmission to that other user, and similarly whether such engagement activities and their modeled embodiments would survive a merger in certain circumstances, given the timeframes and prevailing contextual data originally recorded. The verification process can verify if the referral should be made. Optionally, for example, the verification process can include an email process for determining whether an outbound email carrying the traceable link matches the default parameters required for transmission to the other user. The verification processor verifies the referrals to allow a first user to refer the registered content to a second user, and allows that second user to refer the registered content to other users. In other embodiments, the verification processor includes a process for assigning the content registered by a user, a unique identifier by generating a hash value and storing the hash value in a database as part of a record of the registered piece of content. Further, the verification processor 132 can include a process to prevent earlier registered content, from being registered by a new user.

The merger process can reconcile pursuant to applicable rules any aspects and allocations not subject to recipient discretionary input that are the subject of conflicts arising between (i) the then-applicable agreed referral framework for a then-eligible referrer, and (ii) such referrer's previously applicable agreed referral framework for such network of digital content.

FIG. 11A and Tables 11B-1 and 11B-2 show an example of how multiple and complex paths of various lengths, splits/compositions among multiple users can result in a user being traceably exposed and measurably introduced to content. For this example, in order to award credit for the measured introduction of one user, User 18 1102, on FIG. 11A, there are 9 separate scored paths that must be tracked/allocated that end from a propagation perspective, and begin from an introduction measurement credit perspective, with the representative node of User 18 at 1104. The paths comprise the following users in order, and an example of a mechanism of scoring them is presented in Tables 11B-1 and 11B-2.

Path 1=Users 1, 2, 3, 4, 11, 13, 15, 17, 18, via the path of representation nodes in direction from content root to measured introduction following 1R1 (1106), 1R2, 1R3, 1R4, 1R11, 1R13, 1R15, 1R17, 1R18 (1104).

Path 2=Users 5, 6, 11, 13, 15, 17, 18, via the path of representation nodes in direction from content root to measured introduction following 1R5 (1108), 1R6, 1R11, 1R13, 1R15, 1R17, 1R18 (1104).

Path 3=Users 5, 6, 8, 15, 17, 18, via the path of representation nodes in direction from content root to measured introduction following 1R5 (1108), 1R6, 1R8, 1R15, 1R17, 1R18 (1104).

Path 4=Users 1, 2, 3, 4, 11, 16, 17, 18, via the path of representation nodes in direction from content root to measured introduction following 1R1 (1106), 1R2, 1R3, 1R4, 1R11, 1R16, 1R17, 1R18 (1104).

Path 5=5, 6, 11, 14, 16, 17, 18, via the path of representation nodes in direction from content root to measured introduction following 1R5 (1108), 1R6, 1R11, 1R14, 1R16, 1R17, 1R18 (1104).

Path 6=1, 14, 16, 17, 18, via the path of representation nodes in direction from content root to measured introduction following 1R1 (1106), 1R14, 1R16, 1R17, 1R18 (1104).

Path 7—1, 2, 3, 16, 17, 18, via the path of representation nodes in direction from content root to measured introduction following 1R1 (1106), 1R2, 1R3, 1R16, 1R17, 1R18 (1104).

Path 8=5, 6, 7, 9, 12, 16, 17, 18, via the path of representation nodes in direction from content root to measured introduction following 1R5 (1108), 1R6, 1R7, 1R9, 1R12, 1R16, 1R17, 1R18 (1104).

Path 9=5, 6, 7, 10, 12, 16, 17, 18, via the path of representation nodes in direction from content root to measured introduction following 1R5 (1108), 1R6, 1R7, 1R10, 1R12, 1R16, 1R17, 1R18 (1104).

In this example, all paths end in User 18's representation node 1104 and all begin with either User 1's or User 5's representation nodes, 1106 and 1108, respectively, representing the two users who independently identified and registered the content. The details of the allocation/scoring are less important for this depicted example than the complexity that must be structurally built and managed for scoring indirectly, not simply by multiple levels of connections, but by multiple levels, lengths, and compositions of paths.

While the tables depicted in the following Tables 11B-1 and 11B-2 follow a simple mathematical split of available points as a function of distance from User 18 1102's representative node 1104, the system will facilitate multiple parties making adjustments of allocations between sharer and recipient, and otherwise generally or circumstantially/ad hoc, etc., so that represents an additional layer of complexity and required control.

TABLE 11B-1
Hypothetical Points Calculation/Allocation among Complex Paths

| | | | | | | |
|---|---|---|---|---|---|---|
| User Share Path | 1 | 2 | 3 | 4 | 11 | 13 |
| Points | 0.04882813 | 0.09765625 | 0.1953125 | 0.390625 | 0.78125 | 1.5625 |
| User Share Path | | | 5 | 6 | 11 | 13 |
| Points | | | 0.1953125 | 0.390625 | 0.78125 | 1.5625 |
| User Share Path | | | | 5 | 6 | 8 |
| Points | | | | 0.78125 | 1.5625 | 3.125 |
| User Share Path | 1 | 2 | 3 | 4 | 11 | 14 |
| Points | 0.01627604 | 0.03255208 | 0.06510417 | 0.13020833 | 0.26041567 | 0.52083333 |
| User Share Path | | | 5 | 6 | 11 | 14 |
| Points | | | 0.06510417 | 0.13020833 | 0.26041667 | 0.52083333 |
| User Share Path | | | | | 1 | 14 |
| Points | | | | | 0.52083333 | 1.04166667 |
| User Share Path | | | | 1 | 2 | 3 |
| Points | | | | 0.52083333 | 1.04166667 | 2.08333333 |
| User Share Path | | 5 | 6 | 7 | 9 | 12 |
| Points | | 0.06510417 | 0.13020833 | 0.25041667 | 0.52083333 | 1.04166667 |
| User Share Path | | 5 | 6 | 7 | 10 | 12 |
| Points | | 0.06510417 | 0.13020833 | 0.26041667 | 0.52083333 | 1.04166667 |

| | | | | Total Points |
|---|---|---|---|---|
| Hypothetical Points Calculation/Allocation among Complex Paths | | | | Σ by Path |
| User Share Path | 15 | 17 | 18 | |
| Points | 4.16666667 | 8.33333333 | 11.1111111 | Σ = 26.687283 |
| User Share Path | 15 | 17 | 18 | |
| Points | 4.16666667 | 8.33333333 | 11.1111111 | Σ = 26.5407986 |
| User Share Path | 15 | 17 | 18 | |
| Points | 4.16666667 | 8.33333333 | 11.1111111 | Σ = 29.0798611 |
| User Share Path | 16 | 17 | 18 | |
| Points | 2.08333333 | 4.16666667 | 11.1111111 | Σ = 18.3865017 |
| User Share Path | 16 | 17 | 18 | |
| Points | 2.08333333 | 4.16666667 | 11.1111111 | Σ = 18.3376736 |
| User Share Path | 16 | 17 | 18 | |
| Points | 2.08333333 | 4.16666667 | 11.1111111 | Σ = 18.9236111 |
| User Share Path | 16 | 17 | 18 | |
| Points | 2.08333333 | 4.16666667 | 11.1111111 | Σ = 21.0069444 |
| User Share Path | 16 | 17 | 18 | |
| Points | 2.08333333 | 4.16666667 | 11.1111111 | Σ = 19.3793403 |
| User Share Path | 16 | 17 | 18 | |
| Points | 2.08333333 | 4.16666667 | 11.1111111 | Σ = 19.3793403 |

| | |
|---|---|
| Grand Total Σ of Paths | Σ = 197.721394 |

TABLE 11B-2
Total Points Σ By User

| User | Σ of Points |
|---|---|
| 18 | 100 |
| 17 | 50 |
| 16 | 12.5 |
| 15 | 12.5 |
| 14 | 2.083333333 |
| 13 | 3.125 |
| 12 | 2.083333333 |
| 11 | 2.083333333 |
| 10 | 0.520833333 |
| 9 | 0.520833333 |
| 8 | 3.125 |
| 7 | 0.520833333 |
| 6 | 2.34375 |
| 5 | 1.171875 |
| 4 | 0.520833333 |
| 3 | 2.34375 |
| 2 | 1.171875 |
| 1 | 1.106770833 |
| Total | 197.7213542 |

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk, flash memory devices, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Those of skill would further appreciate that the various illustrative logical blocks, modules, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein.

The techniques or steps of a method described in connection with the embodiments disclosed herein may be embodied directly in hardware, in software executed by a processor, or in a combination of the two.

Accordingly, it will be understood that the invention is not to be limited to the embodiments disclosed herein, but is to be understood from the following claims, which are to be interpreted as broadly as allowed under the law.

1. A method for ranking a user's role in propagation of content, comprising
allowing a first user to register a piece of content,
allowing the first user to refer the registered content to a second user,
allowing the second user to refer the registered content to other users,
tracking the propagation of the registered content among the users, and
ranking a respective user's relevance in propagating the registered content among the other users, as a function of the order in which the respective user referred content to other users.

2. A method according to claim 1, wherein tracking includes
generating a network model having nodes and associations between the nodes, wherein the nodes represent an action by a user for propagating the registered content and associations represent traceable associations having information that describes a process a user employed to engage another user.

3. A method according to claim 2, wherein the traceable association stores information selected from the group of emailing content, posting content, and tagging keywords in a search engine

4. A method according to claim 1, wherein registering content includes generating a root node for a data network model.

5. A method according to claim 1, wherein allowing a first user to register a piece of content includes assigning the content a unique identifier by generating a hash value and storing the hash value in a database as part of a record of the registered piece of content.

6. A method according to claim 1, wherein allowing a first user to register a piece of content includes preventing the first user from registering a piece of content previously registered by a user.

7. A method according to claim 6, wherein preventing registration of previously registered content includes generating a database of root nodes representing registered content at the root of a plurality of data network models.

8. A method according to claim 2, further including generating an engagement network node upon exposing a new user to registered content.

9. A method according to claim 8, further including generating a traceable association between the engagement network node and a network node associated with an event that a user employed to propagate the content to the new user.

10. A method according to claim 1, wherein ranking a user includes using a measurement processor to determine credit for a user as a function of reviewing data stored with traceable links associated with the user and at least one of a number, type, velocity, and or consistency of the user's engagement actions with the registered content.

11. A system for ranking a user's role in propagation of content, comprising
a content processor for allowing a first user to register a piece of content,
a verification processor for allowing the first user to refer the registered content to a second user, and for allowing the second user to refer the registered content to other users, and
a measurement processor for tracking the propagation of the registered content among the users, and for ranking a respective user's relevance in propagating the registered content among the other users, as a function of the order in which the respective user referred content to other users.

12. A system according to claim 11, wherein the measurement processor includes
a network model generator for generating network models or graphs having nodes and
associations between the nodes, wherein the nodes represent an action by a user for propagating the registered content and associations represent traceable associations having information that describes a process a user employed to engage another user.

13. A system according to claim 12, wherein the traceable association stores information representative of a process employed for engaging a user.

14. A system according to claim 11, wherein the verification processor includes
a process for allowing a first user to register a piece of content includes assigning the content a unique identifier by generating a hash value and storing the hash value in a database as part of a record of the registered piece of content.

15. A system according to claim 14, wherein the verification process includes a process for preventing the first user from registering a piece of content previously registered by a user.
